(19) United States
(12) Patent Application Publication
(10) Pub. No.: US 2024/0279092 A1
(43) Pub. Date: Aug. 22, 2024

(54) SYSTEM AND METHOD FOR ANALYZING AND USING SEPTIC SYSTEM DATA

(71) Applicant: Lee Rashkin, Dalton, NH (US)

(72) Inventor: Lee Rashkin, Dalton, NH (US)

(21) Appl. No.: 18/444,034

(22) Filed: Feb. 16, 2024

Related U.S. Application Data
(60) Provisional application No. 63/446,472, filed on Feb. 17, 2023.

(51) Int. Cl. C02F 3/00

(52) U.S. Cl. CPC C02F 3/00; C02F 2209/00

(57) ABSTRACT

Systems and techniques are provided herein for using a variety of different data sources to determine a septic score that represents the overall health of a septic system. In some embodiments, the septic score or any of the variables used to generate the septic score are also used to make predictions with regards to the lifespan of a given septic system or to other relevant considerations like predicted costs. In still other embodiments, various septic system parameters can be used to design various types of septic systems that are presented to a user.

### CROSS REFERENCE TO RELATED APPLICATION

This application claims benefit under 35 U.S.C. § 119(e) to U.S. Provisional Application No. 63/446,472, filed Feb. 17, 2023, the disclosure of which is incorporated by reference herein in its entirety.

### FIELD OF THE DISCLOSURE

This disclosure relates generally to the field of septic and wastewater systems, and more particularly, to techniques for generating metrics for evaluating septic and wastewater systems, designing septic systems, and providing a highest quality of service for septic systems.

### BACKGROUND

Septic tanks are underground chambers attached via plumbing to a building through which wastewater (e.g., sewage) flows to a leach field for treatment before being expelled away from the building. Typically, septic tanks are used for rural or suburban structures that are too far from cities or other densely populated areas that use a municipal sewage system. These systems are often overlooked or forgotten by homeowners or potential home buyers. For many systems, the only maintenance performed by the homeowner is to have sludge that accumulates in the system periodically pumped out using a vacuum truck. However, when one of these systems fails, it can be a very costly and messy problem to deal with. Unfortunately, there is very little information available to help homeowners or home buyers make informed decisions with regards to septic systems.

### SUMMARY

Systems and techniques are provided herein for using a variety of different data sources to determine a septic score that represents the overall health of a septic system. In some embodiments, the septic score or any of the variables used to generate the septic score are also used to make predictions with regards to the lifespan of a given septic system or to other relevant considerations like predicted costs. In still other embodiments, various septic system parameters can be used to design various types of septic systems that are presented to a user. Numerous other embodiments will be apparent in light of this disclosure.

Any number of non-transitory machine-readable mediums (e.g., embedded memory, on-chip memory, read only memory, random access memory, solid state drives, and any other physical storage mediums) can be used to encode instructions that, when executed by one or more processors, cause an embodiment of the techniques provided herein to be carried out, thereby allowing for the generation of a septic system score and/or various methods to be carried out using septic system parameters. Likewise, the techniques can be implemented in hardware (e.g., logic circuits such as field programmable gate array, purpose-built semiconductor, microcontroller with a number of input/output ports and embedded routines).

### BRIEF DESCRIPTION OF THE DRAWINGS

FIG. 1 shows an example system having a septic scoring platform, configured in accordance with an embodiment of the present disclosure.

FIG. 2 illustrates a diagram for generating a septic score, in accordance with some embodiments of the present disclosure.

FIG. 3 illustrates a diagram for generating a historical value that is used to generate the septic score from FIG. 2, in accordance with some embodiments of the present disclosure.

FIG. 4 illustrates a diagram for generating a sample value that is used to generate the septic score from FIG. 2, in accordance with some embodiments of the present disclosure.

FIG. 5 illustrates a diagram for generating an inspection value that is used to generate the septic score from FIG. 2, in accordance with some embodiments of the present disclosure.

FIG. 6 illustrates a diagram for generating a geographic value that is used to generate the septic score from FIG. 2, in accordance with some embodiments of the present disclosure.

FIG. 7 illustrates a diagram for generating a feature value that is used to generate the septic score from FIG. 2, in accordance with some embodiments of the present disclosure.

FIG. 8 illustrates a diagram for generating a property value that is used to generate the septic score from FIG. 2, in accordance with some embodiments of the present disclosure.

FIG. 9 illustrates a diagram for generating a demographic value that is used to generate the septic score from FIG. 2, in accordance with some embodiments of the present disclosure.

FIG. 10 is a flow diagram for making predictions based on a septic score and/or septic parameters and determining risk, in accordance with some embodiments of the present disclosure.

FIG. 11 is a flow diagram for determining discrepancies across septic system reports, in accordance with some embodiments of the present disclosure.

FIG. 12 is a flow diagram for designing a septic system, in accordance with some embodiments of the present disclosure.

FIG. 13 is a flow diagram for simulating a septic score based on various septic parameters, in accordance with some embodiments of the present disclosure.

FIG. 14 is a flow diagram for determining if a septic system or proposed septic system is in one or more hotspots, in accordance with some embodiments of the present disclosure.

FIGS. 15A and 15B illustrate an example graphical user interface for displaying a septic score and its components, in accordance with some embodiments of the present disclosure.

FIG. 16A illustrates an example graphical user interface for displaying a septic system score for a given structure and septic scores of surrounding structures in a given area, in accordance with some embodiments of the present disclosure.

FIG. 16B illustrates an example graphical user interface for displaying septic system scores for a broad region, in accordance with some embodiments of the present disclosure.

FIG. 17 shows an example of different layers used in a neural network to determine a septic system score or make predictions about a septic system, in accordance with some embodiments of the present disclosure.

### DETAILED DESCRIPTION

Techniques are provided herein for generating a septic score for a septic system and using the septic score to make various predictions and determinations about various factors associated with the septic system or the structure that the system is connected to. Although a number of applications will be appreciated, the techniques are particularly well-suited in the context of single-family home septic systems to provide valuable home information. The septic system score can be used in a variety of ways to help make informed decisions with regards to the septic system or its associated structure. For example, the septic system score can be provided by any real estate agency or online home-viewing service to provide information for potential homeowners about the health and/or overall effectiveness of the septic system. In some other examples, the septic system score can be used by banks or other lenders to make decisions with regards to property appraisals or mortgage costs. In some other examples, the septic system score can be used by industry professionals such as engineers, installers, designers, or inspectors to provide further information about a given septic system. Various septic system scores in a given region can be used by various technical and environmental officials to make legislative and/or regulation decisions.

According to some embodiments, a septic score is generated by collecting or generating data from multiple different septic system categories, with each category including a plurality of septic system variables associated with the given category. For example, the septic system score can be generated using data from seven different categories: historical data, sample data, inspection data, geographic/environmental data, system features, property data, and socio-demographic data. Variables are collected from each category from different sources, such as online databases or any other record-keeping sources. According to some embodiments, the variables of each category are used together to generate a category value, and the seven category values are then used together to generate the septic system score. The different variable values may be standardized onto a common scale (such as between 0 and 100 or between 0 and 1) and weighted depending on their relative impact to the final septic score.

According to some embodiments, the septic system score is presented to a user via a graphical user interface that provides detailed information about how the score was generated and/or comparative information with other septic system scores in a certain area. In an embodiment, the septic system score is provided along with a graphical representation of the seven categories that make up the septic system score, and their relative impact on the score. Any of the categories can be expanded by a user clicking on a category or moving over the category. The expanded category can further display the relative impact that different variables had on determining the value of the given category. According to some other embodiments, a map of a geographic area can be provided along with septic system scores of different structures in the geographic area indicated on the map. In some examples, average septic system scores for different regions on the map are provided as opposed to individual scores. Colors may be used on the map to indicate the level of the septic system score, like a heat map.

According to some embodiments, the septic system score and/or any of the variables used to generate the septic system score can be used to make predictions about the septic system or the structure is it attached to. Example predictions include a remaining lifespan of the septic system, when or often it needs to be pumped, how much the system will cost yearly or over its lifetime to maintain, its environmental impact over time, building costs, real estate development planning, or warranty costs. The predictions may be based on how other similar septic systems in similar environments have fared, and thus the septic system score or variables for a given septic system can be compared against a database of other septic system data for the same general region to make informed predictions.

According to some embodiments, various septic system parameters and/or location features can be used to design a septic system or to design multiple different septic systems for selection by a user. For example, a user may enter certain parameters such as location information, soil type, environmental factors, desired treatment levels, size of attached structure, and the system can take these parameters and offer different septic system designs with different strengths. In some embodiments, the system can use the entered parameters to offer a septic design that is the best overall design (e.g., yields the highest septic system score). Other offered septic system designs include a longest lasting septic system, lowest profile septic system, smallest footprint septic system, or lowest cost system, to name a few examples. Furthermore, in some embodiments, local contractors, regulators, and/or inspectors can be automatically contacted to provide the user with information about installing and maintaining the septic system. A materials list can also be generated along with local distributors or retailers that offer the needed parts and their associated costs.

As explained above, implementing a system that can accumulate a vast amount of disparate septic tank data and provide meaningful metrics and analysis regarding the state of a real or desired septic system provides a technical solution to understanding cost, efficiency, and environmental impact of the real or desired septic system. Much like how a user can access a credit score to learn about the strength of their credit and their credit history, or how a vehicle report can be generated to learn about whether a particular car is a good investment, a septic system score can provide a user with invaluable information regarding the health and financial investment of their septic system. Furthermore, septic system scores can provide more important criteria to consider when looking to buy a new home.

The techniques may be embodied in devices, systems, methods, or machine-readable mediums, as will be appreciated. For example, according to a first embodiment of the present disclosure, a computer-implemented method for generating a septic system score for a septic system includes identifying, using a processing device, a plurality of septic system categories, wherein each of the septic system categories comprises a plurality of septic system variables associated with the septic system; for each of the septic system categories, generating, using the processing device, a category value based on the plurality of septic system variables corresponding to the category, wherein the generating comprises weighting one or more of the plurality of septic system variables to create weighted variables, and combining the weighted variables to generate the category value; combining, using a processing device, the category values to generate the septic system score; and displaying, using a processing device, the septic system score.

According to another embodiment, a computer program product including one or more non-transitory machine-readable media having instructions encoded thereon that when executed by at least one processor causes a process for generating a septic system score for a septic system as described above.

According to another embodiment, a system configured to generate a septic system score for a septic system includes at least one processor, a data accumulator executable by the at least one processor, a septic score generator executable by the at least one processor, and a display module executable by the at least one processor. The data accumulator is designed to collect a plurality of septic system variables associated with the septic system from across a plurality of different septic system categories. The septic score generator is designed to, for each of the septic system categories, generate a category value based on the plurality of septic system variables corresponding to the category by weighting one or more of the plurality of septic system variables to create weighted variables and combining the weighted variables to generate the category value, and combine the category values to generate the septic system score. The display module is designed to display the septic system score.

According to another embodiment, a computer-implemented method for predicting risk for a septic system includes obtaining a plurality of septic system variables associated with the septic system, assigning numerically weighted values to the plurality of septic system variables to generate weighted variables; selecting at least two of the weighted variables; determining a risk level of the septic system based on the selected at least two weighted variables; storing the risk level in a database configured to store risk levels for a plurality of different septic systems; and in response to the risk level being above a threshold, displaying an alert that indicates the risk level.

According to another embodiment, a computer program product including one or more non-transitory machine-readable media having instructions encoded thereon that when executed by at least one processor causes a process for predicting risk for a septic system as described above.

According to another embodiment, a system configured to generate a risk level for a septic system includes at least one processor, a data accumulator executable by the at least one processor, a prediction module executable by the at least one processor, and a display module executable by the at least one processor. The data accumulator is designed to collect a plurality of septic system variables associated with the septic system. The prediction module is designed to assign numerically weighted values to the plurality of septic system variables to generate weighted variables, select at least two of the weighted variables, determine a risk level of the septic system based on the selected at least two weighted variables, and store the risk level in a database configured to store risk levels for a plurality of different septic systems. The display module is designed to, in response to the risk level being above a threshold, display an alert that indicates the risk level.

According to another embodiment, a method for designing a septic system includes receiving a plurality of septic system parameters via a user input, the plurality of septic system parameters comprising at least a proposed location of the septic system; receiving at least one parameter associated with a structure coupled to the septic system; determining at least a size of the septic system and a type of the septic system based on one or more of the plurality of septic system parameters and the at least one parameter associated with the structure coupled to the septic system; and generating a parts list that includes parts and/or materials needed to build the septic system.

According to another embodiment, a computer program product including one or more non-transitory machine-readable media having instructions encoded thereon that when executed by at least one processor causes a process for designing a septic system as described above.

According to another embodiment, a system configured to design a septic system includes at least one processor, a data accumulator executable by the at least one processor, and a septic design module executable by the at least one processor. The data accumulator is designed to receive a plurality of septic system parameters via a user input, and receive at least one parameter associated with a structure coupled to the septic system. The plurality of septic system parameters include at least a proposed location of the septic system. The septic design module is designed to determine at least a size of the septic system and a type of the septic system based on one or more of the plurality of septic system parameters and the at least one parameter associated with the structure coupled to the septic system, and generate a parts list that includes parts and/or materials needed to build the septic system.

According to another embodiment, a method is provided for identifying and reporting septic system information. The method includes, at predetermined time intervals, gathering reporting documents regarding the septic system from one or more online sources; associating the reporting documents with the septic system and adding the reporting documents to a database that includes a plurality of other reporting documents associated with other septic systems; identifying one or more discrepancies between the reporting documents regarding the septic system; cataloging the one or more discrepancies in the database; and displaying an indication of the one or more discrepancies.

Numerous examples are described herein, and many others will be appreciated in light of this disclosure. For example, although many of the examples herein refer specifically to septic systems, the same techniques can be equally applied to any wastewater management system.

### System Architecture

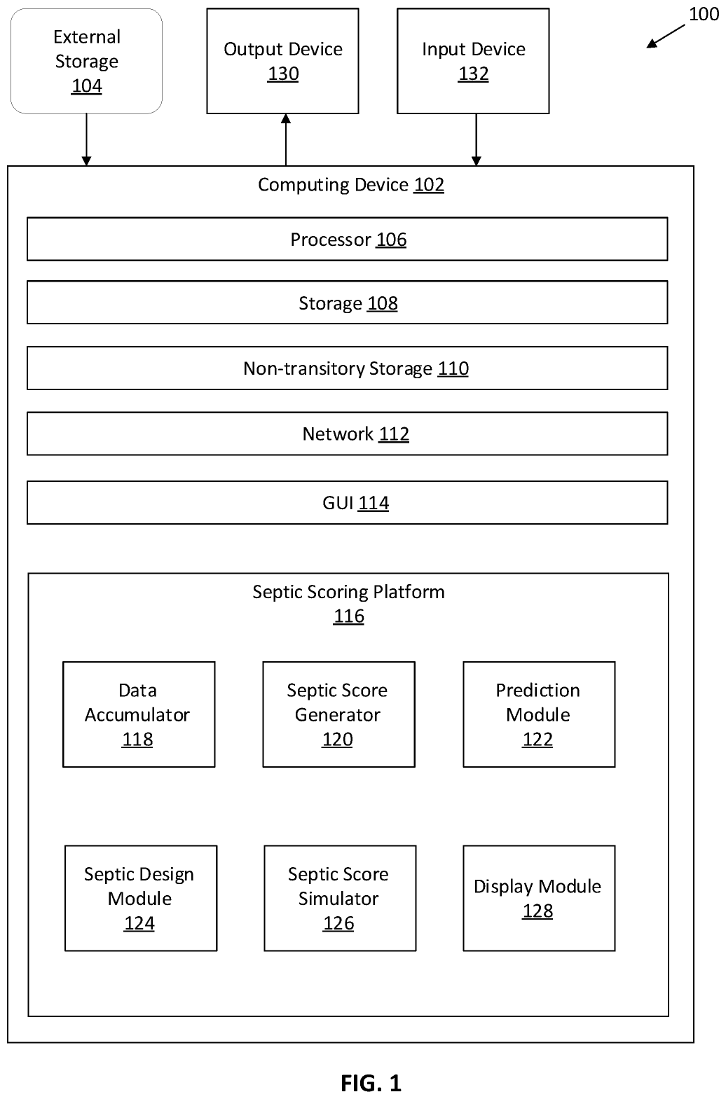

FIG. 1 shows an example system 100 that, among other things, implements a septic scoring platform 116 to generate septic system scores and use septic system scores and/or septic system variables for further analysis, according to an embodiment. The system 100 includes various hardware components such as a computing device 102 having a processor 106, a storage 108, a non-transitory storage medium 110, a network interface 112, and a graphical user interface (GUI) 114. As will be appreciated, septic scoring platform 116 may be part of a more comprehensive web application. GUI 114 may include a display and a user input device. In some embodiments, GUI 114 represents a command-line interface. In some embodiments, computing device 102 represents a web server or any other type of networked computing system that analyzes and organizes septic system data. In this way, computing device 202 communicates with other networked computing devices to receive input (e.g., septic system variables) from such devices and provide output (septic system scores and other associated data) to such devices.

According to some embodiments, processor 106 of the computing device 102 is configured to execute the following components of septic scoring platform 116, each of which is described in further detail below: data accumulator 118, septic scoring generator 120, prediction module 122, septic design module 124, septic score simulator 126, and display module 128. In some embodiments, computing device 102 is configured to store various septic system variables or records in external storage 104 or in storage 108. External storage 104 may be local to device 102 (e.g., plug-and-play hard drive) or remote to device 102 (e.g., cloud-based storage), and may represent, for instance, a stand-alone external hard-drive, external FLASH drive or any other type of FLASH memory, a networked hard-drive, a server, or networked attached storage (NAS), to name a few examples. As will be discussed in more detail herein, each of the components 118, 120, 122, 124, 126, and 128 are used in conjunction with each other to perform a variety of different techniques associated with septic systems. Note that other embodiments may have fewer components or more components. For instance, all of the functionality described could be carried out in one single component, according to some embodiments. Likewise, the function attributed to one component in one embodiment may be carried out by another component in another embodiment. Numerous such variations will be apparent. To this end, the degree of modularity or integration may vary from one embodiment to the next, and the example components provided are not intended to limit the present disclosure to a specific structure.

Computing device 102 can be any computer system, such as a workstation, desktop computer, server, laptop, handheld computer, tablet computer (e.g., the iPad® tablet computer), mobile computing or communication device (e.g., the iPhone® mobile communication device, the Android™ mobile communication device, and the like), virtual reality (VR) device or VR component (e.g., headset, hand glove, camera, treadmill, etc.) or other form of computing or telecommunications device that is capable of communication and that has sufficient processor power and memory capacity to perform the operations described in this disclosure. A distributed computational system can be provided including a plurality of such computing devices. Further note that device 102 may be, for example, a client in a client-server arrangement, wherein at least a portion of the septic scoring platform 116 is served or otherwise made accessible to device 102 via a network (e.g., the Internet and a local area network that is communicatively coupled to the network interface 112).

Computing device 102 includes one or more storage devices 108 or non-transitory computer-readable mediums 110 having encoded thereon one or more computer-executable instructions or software for implementing techniques as variously described in this disclosure. The storage devices 108 can include a computer system memory or random access memory, such as a durable disk storage (which can include any suitable optical or magnetic durable storage device, e.g., RAM, ROM, Flash, USB drive, or other semiconductor-based storage medium), a hard-drive, CD-ROM, or other computer readable mediums, for storing data and computer-readable instructions or software that implement various embodiments as taught in this disclosure. The storage device 108 can include other types of memory as well, or combinations thereof. The non-transitory computer-readable medium 110 can include, but are not limited to, one or more types of hardware memory, non-transitory tangible media (for example, one or more magnetic storage disks, one or more optical disks, one or more USB flash drives), and the like. The non-transitory computer-readable medium 110 included in the computing device 102 can store computer-readable and computer-executable instructions or software for implementing various embodiments (such as instructions for an operating system as well as data analysis that are a part of septic scoring platform 116). The computer-readable medium 110 can be provided on the computing device 102 or provided separately or remotely from the computing device 102.

The computing device 102 also includes at least one processor 106 for executing computer-readable and computer-executable instructions or software stored in the storage device 108 or non-transitory computer-readable medium 110 and other programs for controlling system hardware. Processor 106 may have multiple cores to facilitate parallel processing or may be multiple single core processors. Any number of processor architectures can be used (e.g., central processing unit and co-processor, graphics processor, digital signal processor). Virtualization can be employed in the computing device 102 so that infrastructure and resources in the computing device 102 can be shared dynamically. For example, a virtual machine can be provided to handle a process running on multiple processors so that the process appears to be using only one computing resource rather than multiple computing resources. Multiple virtual machines can also be used with one processor. Network interface 112 can be any appropriate network chip or chipset which allows for wired or wireless connection between the computing device 102 and a communication network (such as local area network) and other computing devices and resources.

A user can interact with the computing device 102 through a networked output device 130, such as a screen or monitor, which can graphically display the septic system score for a particular septic system along with various parameters associated with the septic system, as provided in accordance with some embodiments. Computing device 102 can include networked input or input/output devices 132 for receiving input from a user, for example, a keyboard, a joystick, a game controller, a pointing device (e.g., a mouse, a user's finger interfacing directly with a touch-sensitive display device, etc.), voice input, or any suitable user interface, including an AR headset. The computing device 102 may include any other suitable conventional I/O peripherals. In some embodiments, computing device 102 includes or is operatively coupled to various suitable devices for performing one or more of the aspects as variously described in this disclosure.

The computing device 102 can run any operating system, such as any of the versions of Microsoft® Windows® operating systems, the different releases of the Unix® and Linux® operating systems, any version of the MacOS® for Macintosh computers, any embedded operating system, any real-time operating system, any open source operating system, any proprietary operating system, any operating systems for mobile computing devices, or any other operating system capable of running on the computing device 102 and performing the operations described in this disclosure. In an embodiment, the operating system can be run on one or more cloud machine instances.

In other embodiments, the functional components/modules can be implemented with hardware, such as gate level logic (e.g., FPGA) or a purpose-built semiconductor (e.g., ASIC). Still other embodiments can be implemented with a microcontroller having several input/output ports for receiving and outputting data, and several embedded routines for carrying out the functionality described in this disclosure. In a more general sense, any suitable combination of hardware, software, and firmware can be used, as will be apparent.

As will be appreciated in light of this disclosure, the various modules and components of the system, such as septic scoring platform 116, data accumulator 118, septic scoring generator 120, prediction module 122, septic design module 124, septic score simulator 126, display module 128, GUI 114, or any combination of these, may be implemented in software, such as a set of instructions (e.g., HTML, XML, C, C++, object-oriented C, JavaScript®, Java®, BASIC, etc.) encoded on any machine-readable medium or computer program product (e.g., hard drive, server, disc, or other suitable non-transitory memory or set of memories), that when executed by one or more processors, cause the various methodologies provided in this disclosure to be carried out. It will be appreciated that, in some embodiments, various functions and data transformations performed by the user computing system, as described in this disclosure, can be performed by one or more suitable processors in any number of configurations and arrangements, and that the depicted embodiments are not intended to be limiting. Various components of this example embodiment, including the computing device 102, can be integrated into, for example, one or more desktop or laptop computers, workstations, tablets, smart phones, game consoles, VR devices, set-top boxes, or other such computing devices. Other componentry and modules typical of a computing system, will be apparent.

According to some embodiments, data accumulator 118 is configured to collect data from across numerous different networked databases, data stores, or manually inputted data regarding different aspects of a septic system. For example, data accumulator 118 can collect historical data regarding the septic system from municipal records, various electronic records, networked databases, and/or user-inputted parameters. Some examples of historical data include the age of the septic system, important dates when the septic system was pumped or inspected, dates of any upgrades or alterations made to the system, dates that service calls were made regarding the system, information about the manufacturer or installer of the septic system, or data regarding how heavily the septic system was used. Data accumulator 118 can also collect sample data from any inspection records, regulatory records, or user-inputted parameters. The records may be found in one or more networked databases. Some examples of sample data include constituent analysis of the wastewater in the septic system, influent vs. effluent analysis, types of treatment and/or how regularly it was applied, sludge data, or sludge composition. Data accumulator 118 can also collect inspection data based on inspection records or manually inputted data from a licensed inspector. Some examples of inspection data include notes and comments made in inspection records, dates of inspections, regulatory compliance data, ratings given to the inspectors, data gleaned from inspection photographs of the septic system, or valuation data provided by inspectors or town regulators. Data accumulator 118 can also collect geographic and/or environmental data based on various ecological or geographic reports generated for a given region, or from manually inputted data. Some examples of geographic and/or environmental data include soil data, water table data, regional sewage use data, weather data, or location data that describes the regional climate or topography. Also included can be assessments of photographs such as satellite or drone photographs of the property being evaluated. Data accumulator 118 can also collect system features based on physical attributes of the septic system itself. Such system features can be manually entered or gleaned from permits, inspection reports or other work-order reports generated for the septic system. Some examples of system features include manufacturer, model, overall septic system design, filter design, pump design, tank size, leach field design, warranty information, or replacement costs for individual components of the septic system. Data accumulator 118 can also collect property data from town records, real-estate records, or manual user input. Some examples of property data include zoning information, a size of the property associated with the septic system, a purpose of the property, or a size of any structures on the property that use the septic system. Data accumulator 118 can also collect socio-demographic data based on census reports, town records, or manual user input. Some examples of socio-demographic data include economic factors, census data, real estate data, or failure data of nearby septic systems. According to some embodiments, any of the data received or collected by data accumulator 118 is stored in a database and linked with its associated septic system. The database may include septic system parameters for a plurality of different septic systems.

According to some embodiments, septic score generator 120 is designed to use any of the septic system data collected from data accumulator 118 to generate a septic system score that represents an overall quality of the septic system. The septic system score can be provided on any given scale that would be readily understood by a user. For example, a septic system score can be provided between 1 and 100 with 1 being the lowest score and 100 being the highest score. The score may be generated by using any combination of data normalization and weighting to represent each of the data values on a comparable scale, weight the values based on their impact, and combine the values using a statistical comparison technique and/or any number of machine learning models. For example, different septic tank parameters can each be represented as a number between 0 and 1, or any number on a common scale. Each parameter can then be multiplied by a weight between 0 and 1 based on its relative impact. Next, a geometric mean, or some other statistical comparison technique, is taken using the weighted parameters to arrive at the septic system score, according to some embodiments. In some embodiments, septic score generator 120 can also look across various inspection, regulatory, and/or other town reports associated with a given septic system to identify any discrepancies in the reports.

According to some embodiments, septic score generator 120 uses deep learning artificial intelligence (AI) based on collected septic system data from across any number of different septic systems to generate a septic system score for a given set of septic system data values. For example, a neural network can be trained using collected septic system data in a supervised or unsupervised fashion to generate the septic system score.

According to some embodiments, multi-criteria decision analysis (MCDA) can be used by septic score generator 120 to evaluate all of the various septic system parameters and historical data for a given system to determine the septic system score. Techniques like Analytic Hierarchy Process (AHP) or Technique for Order Preference by Similarity to Ideal Solution (TOPSIS) can be applied to septic system scoring.

According to some embodiments, a prediction module 122 is designed to estimate certain predictive features of the septic system based on the septic system score and/or various septic system parameters. In some examples, prediction module 122 uses data from an already-installed septic system, data associated with a location for which a septic system is not yet installed, or data from other similar septic systems to make predictions about a variety of factors. For example, predictions can be made regarding installation costs, maintenance costs, valuation, warranty cost, or lifetime cost of ownership. Non-financial predictions can include real-estate development information by comparing with other systems in the same general neighborhood or predictions regarding septic system efficiency overtime or total expected lifetime. In some embodiments, specific predictions can be made based on certain hypothetical parameters that can be manually entered. For example, by entering the type of septic system, daily flow rate of the system, and any other similar parameters, prediction module 122 can output a likely performance level of the septic system along with its predicted cost of ownership and/or expected maintenance schedule.

According to some embodiments, septic design module 124 is configured to generate one or more septic system designs based on one or more inputted septic system parameters and location data. For example, upon receipt of a location for the septic system, septic design module 124 can access location-based data for the chosen location to determine various parameters related to zoning data, geographic data, environmental data, etc. Other desired parameters such as particular system features or size and type of structure that is being supported by the septic system can also be entered. Upon receipt of the various septic system parameters, septic design module 124 is configured to provide septic system options for a user, according to some embodiments. The options may each have different advantages. For example, one septic system option provides the best overall value, another septic system option provides a system with a lowest overall footprint, another septic system option provides a system with a lowest upfront cost, etc. For any of the septic system options, septic design module 124 can also generate a parts and materials list of what is needed to build and install the septic system. According to some embodiments, septic design module 124 can search inventories of local retailers or distributers to find the necessary parts and provide cost estimates or quotes for purchasing of the parts and/or for installation of the system. Regulatory documents and/or any other required formal documents may also be auto-generated based on the desired septic system criteria.

According to some embodiments, septic score simulator 126 is configured to provide real-time feedback to septic system scores based on changing parameters and/or parameter values. For example, septic score simulator 126 can receive changes to certain septic system parameters and show how those changes affect the final septic system score. In some embodiments, the impact that certain parameters have on the final score can be graphically illustrated using different colors, shapes, or sizes to represent the impact. In some embodiments, septic score simulator 126 can identify those parameters that are most influential in creating a low septic system score and provide suggestions for improving the septic system score that are related to the parameters causing the low score. For example, if a low septic system score is caused by a septic system not being pumped regularly, septic score simulator 126 can identify this situation and suggest that the system be pumped more regularly. In some embodiments, septic score simulator 126 can also provide the updated septic system score if the system was pumped more regularly. In some other embodiments, septic score simulator 126 can provide the minimum work necessary in order to exceed a particular septic score threshold.

According to some embodiments, display module 128 is configured to provide the septic system score or any factors associated with the septic system score on a display. The information can be arranged and displayed as part of GUI 114 to allow a user to interact with different score features. In one example, the septic system score is provided within a colored ring having various segments that identify what data categories were used to generate the septic system score. A size of each of the category segments represents how impactful that data was on generating the score, according to an embodiment. A user can click on any of the ring segments to learn more about the given data category. In another example, display module 128 displays a map of a geographic region that includes a particular septic system, identified with its septic system score, and also shows other septic systems in the area long with their scores or an average of their scores.

### Generating a Septic System Score

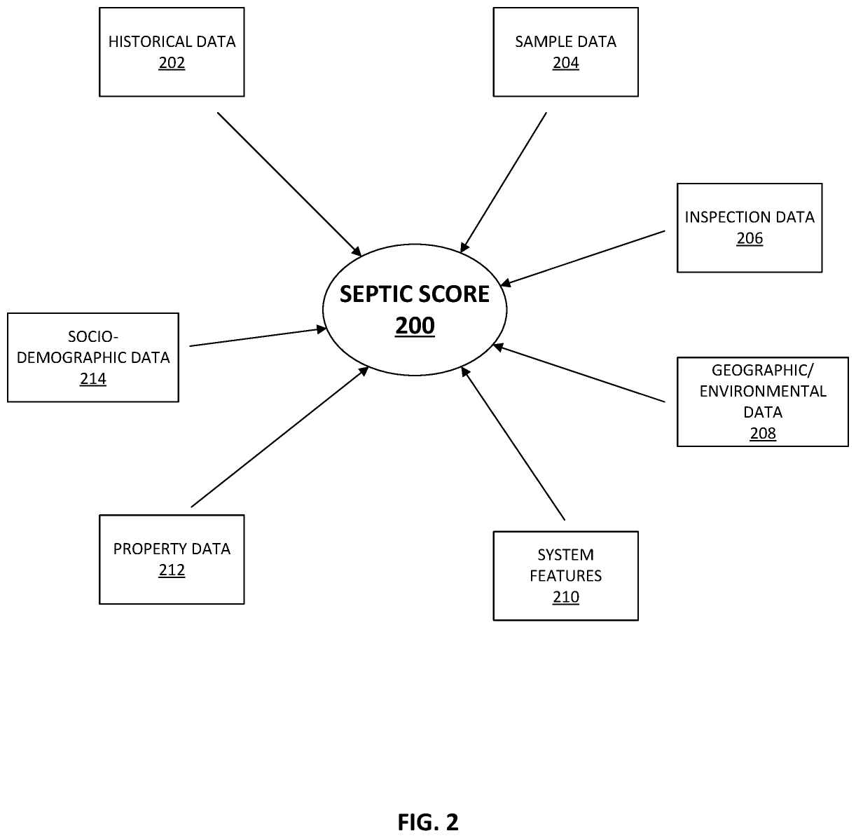

FIG. 2 illustrates a flowchart for providing a septic system score 200 based on different categories of data. Seven different data categories are shown, however, the number of different data categories may be different depending on what data is available and the desired level of precision for septic system score 200. According to some embodiments, the data categories include one or more of historical data 202, sample data 204, inspection data 206, geographic/environmental data 208, system features 210, property data 212, and socio-demographic data 214.

According to some embodiments, each data category represents a collection of septic system variables that are averaged or otherwise combined in some fashion to generate a category value for each of the categories. In the illustrated example, seven category values would be generated with one from each of the seven different categories. According to some embodiments, the category values are weighted based on their relative impact to the final score. Weighting may be predetermined based on known factors regarding the operation of septic systems or weighting may be based on an analysis of other septic systems in the same area or from the same manufacturer. In some embodiments, different variables can be weighted based on their relationship with other variables. Any number of different mathematical models can be used to define the relationships between any of the septic system variables. The category values may be provided on the same scale so as to be comparable with one another, such as values between 0 and 1. According to some embodiments, a geometric mean is taken of the seven category values or weighted values to determine the septic score. According to some other embodiments the category values are averaged (or a weighted average is determined from the weighted scores) to determine the septic score.

According to some embodiments, one or more of the various septic system variables from each of the data categories are retrieved from various online sources and/or databases that maintain such septic system data. In some embodiments, one or more of the various septic system variables are manually entered by a user interested in determining a septic score for a particular septic system, or by septic field professionals like installers, manufacturers, inspectors, or regulators, to name a few examples. In some embodiments, the operations of retrieving the various septic system variables from across the different data categories and combining the values to determine septic system score 200 are performed by data accumulator 118 and septic score generator 120. Any of the septic system variables may be time-dependent variables that are updated at pre-determined time intervals.

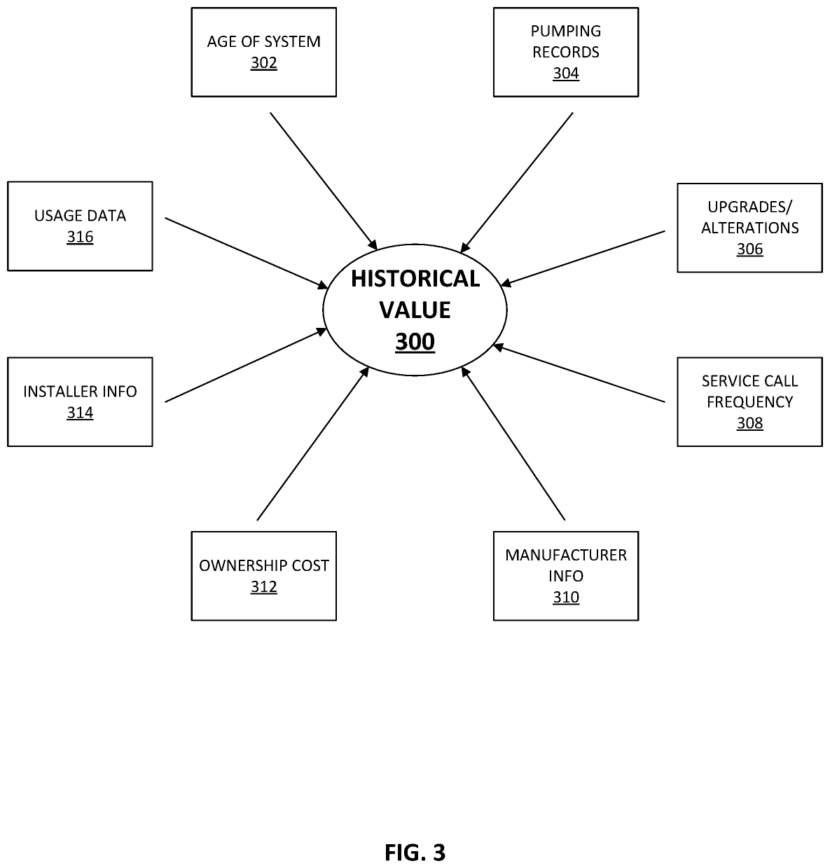

FIG. 3 illustrates a flowchart for determining a historical value 300, which represents the category value attributed to historical data category 202. Historical value 300 is generated based on a variety of different septic system historical variables. Example septic system historical variables include the system's age 302, pumping records 304, upgrades 306, service call frequency 308, manufacturer information 310, ownership cost 312, installer information 314, and usage data 316. It should be understood that any number of septic system historical variables can be collected to determine historical value 300. According to some embodiments, any of the septic system historical variables are used to train or update a neural network model configured to generate a septic system score.

Septic system age 302 represents how many years and/or months it has been since the given septic system was installed, according to some embodiments. Older septic systems may lower historical value 300 due to a greater risk of failure. Septic system age 302 may be manually entered or retrieved from installation records for a given septic system.

Pumping records 304 represent a frequency that the given septic system is pumped, according to some embodiments. Depending on the size and usage of the system, pumping recommendations may vary between every year and every 4 years. Historical value 300 may be negatively impacted by a system that is not pumped regularly. According to some embodiments, pumping records 304 is provided as a value between 0 and 1 that is normalized based on a comparison with the pumping frequency of other similarly installed and/or used septic systems in the area. Pumping records 304 may be manually entered or retrieved from inspection records or contractor records (from contractors that perform the pumping service) for a given septic system.

Upgrades 306 represent any upgrades that have been in the past to the system, according to some embodiments. Upgrades 306 may be realized as a value between 0 and 1, with 0 meaning no upgrades performed and 1 meaning the entire system has been recently retrofitted or upgraded. Upgrades to particular parts or sections of the septic system would be represented by some value between 0 and 1 depending on the importance of the upgrade. Historical value 300 may be positively impacted by a system that has been upgraded recently. Upgrades 306 may be manually entered or retrieved from inspection records or contractor records (from contractors that performed the upgrade) for a given septic system.

Service call frequency 308 represents a frequency that service calls have been made regarding the septic system, according to some embodiments. A high frequency of service calls, compared to similarly situated systems, is a red flag for a failing or suspect system and may negatively impact the historical value 300. According to some embodiments, service call frequency 308 is provided as a value between 0 and 1 that is normalized based on a comparison with the service call frequency of other septic systems in the area. Service call frequency 308 may be manually entered or retrieved from phone records or contractor records (from contractors that receive the service calls) for a given septic system.

Manufacturer information 310 represents ratings or any other quantitative evaluations of the manufacturer of the septic system, according to some embodiments. A low-rated manufacturer may negatively impact the historical value 300. According to some embodiments, manufacturer information 310 is provided as a value between 0 and 1 that is normalized based on a comparison with the ratings or evaluations of other manufacturers. Manufacturer information 310 may be manually entered or retrieved from installation or inspection records for a given septic system. In some examples, manufacturer information 310 is retrieved from online sources that store such ratings or evaluations of manufacturers.

Ownership cost 312 represents costs that the septic system has required over the years either due to normal maintenance or repairs, according to some embodiments. High ownership costs can negatively impact the historical value 300. According to some embodiments, ownership cost 312 is provided as a value between 0 and 1 that is normalized based on a comparison with the ownership costs of other septic systems in the area. Ownership cost 312 may be manually entered or retrieved from contractor records (from contractors that perform the maintenance or repairs) for a given septic system.

Installer information 314 represents ratings, certifications, approvals, education, experience or any other quantitative evaluations of the installer of the septic system, according to some embodiments. A low-rated installer may negatively impact the historical value 300. According to some embodiments, installer information 314 is provided as a value between 0 and 1 that is normalized based on a comparison with the ratings or evaluations of other local installers. Installer information 314 may be manually entered or retrieved from installation records for a given septic system. In some examples, installer information 314 is retrieved from online sources that store such ratings or evaluations of installers.

Usage data 316 represents the level of use the septic system receives over a certain time period. Usage data 316 may be realized as a value between 0 and 1, with 0 meaning no use at all and 1 meaning the highest usage rate compared to all other septic systems in a given area. Usage data 316 may be manually entered or retrieved from sensor data from one or more sensors on the septic system that can detect its level of use.

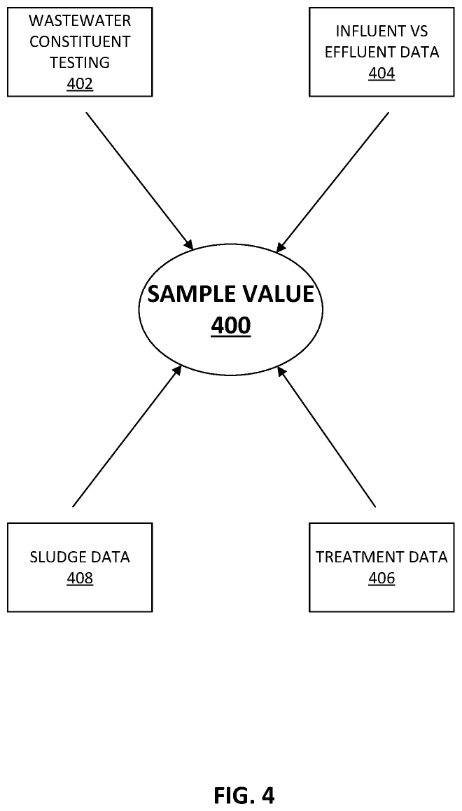

FIG. 4 illustrates a flowchart for determining a sample value 400, which represents the category value attributed to the sample data category 204. Sample value 400 is generated based on a variety of different septic system sample variables and provides a quantitative assessment of the treatment effectiveness of the system. Example septic system sample variables include wastewater constituent values 402, influent vs. effluent data 404, septic treatments 406, and sludge data 408. It should be understood that any number of septic system sample variables can be collected to determine sample value 400. According to some embodiments, any of the septic system sample variables are used to train or update a neural network model configured to generate a septic system score.

Wastewater constituent values 402 represent data associated with measurable characteristics of the wastewater in the septic system, according to some embodiments. The chemical composition of the wastewater can provide insight into the overall health of the septic system. Some examples of wastewater constituents to be evaluated include biochemical oxygen demand (BOD), total suspended solids (TSS), pathogens, nutrients, and contaminants of emerging concern (CEC). According to some embodiments, wastewater constituent values 402 can include different values for each constituent that are normalized to a value between 0 and 1 based on a comparison with the constituent values of other septic systems in the area. Wastewater constituent values 402 may be manually entered or retrieved from contractor records (from contractors that perform constituent testing) or inspection reports for a given septic system. More generally, wastewater constituent values 402 can be obtained from any municipal, federal, governmental, or academic reports or records, or from data collected by an NGO or private sector company. In some embodiments, sensors affixed to the septic system or near the septic system can provide one or more of the wastewater constituent values 402.

Influent/effluent data 404 represents data associated with measurable characteristics of the influent compared to the effluent portions of the septic system, according to some embodiments. The influent wastewater is the raw wastewater that enters the system while the effluent wastewater is the water that leaves the system. For a healthy septic system, the effluent wastewater should exhibit substantially fewer contaminants and overall waste compared to the influent wastewater. According to some embodiments, influent/effluent data 404 can include a ratio between measurable characteristics of the influent vs. the effluent wastewater. The ratio can be transformed into a value between 0 and 1 based on a comparison with the influent/effluent data of other septic systems in the area. Influent/effluent data 404 may be manually entered or retrieved from contractor records (from contractors that perform wastewater testing) or inspection reports for a given septic system. In some embodiments, sensors affixed to or near the inlet or outlet of the septic system can provide some or all of influent/effluent data 404.

Treatment data 406 represents data associated with frequency of and type of treatments applied to the septic system wastewater, according to some embodiments. Frequent treatments using chemicals known to help break down solids may have a positive impact on sample value 400. Treatment data 406 may be represented as a value between 0 and 1 based on a comparison with the treatment data of other septic systems in the area. Treatment data 406 may be manually entered or retrieved from contractor records (from contractors that perform the treatment themselves) for a given septic system. In some embodiments, sensors affixed to or near the septic system can provide some or all of treatment data 406.

Sludge data 408 represents data associated with how quickly sludge accumulates (e.g., a sludge rate) in the septic system or a total current sludge data, according to some embodiments. Sludge that builds up quickly may be a sign of misuse or a poorly designed septic system, and a high sludge rate can negatively impact sample value 400. Sludge data 408 may be represented as a value between 0 and 1 based on a comparison with the sludge data of other septic systems in the area. Sludge data 408 may be manually entered or retrieved from contractor records (from contractors that pump out the sludge), or from inspection reports for a given septic system. In some embodiments, sensors affixed to or near the septic system can provide some or all of sludge data 408.

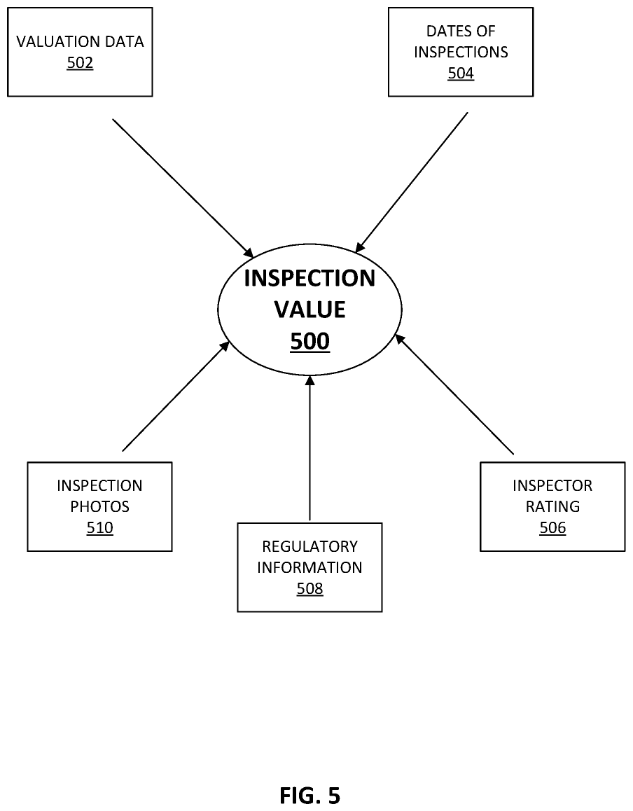

FIG. 5 illustrates a flowchart for determining an inspection value 500, which represents the category value attributed to the inspection data category 206. Inspection value 500 is generated based on a variety of different septic system inspection variables. Example septic system inspection variables include valuation data 502, inspection dates 504, inspector rating 506, regulatory data 508, and inspection photos 510. It should be understood that any number of septic system inspection variables can be collected to determine inspection value 500. According to some embodiments, any of the septic system inspection variables are used to train or update a neural network model configured to generate a septic system score.

Valuation data 502 represent any estimation of the worth of the septic system provided by a licensed professional such as an installer or inspector, according to some embodiments. Valuation data 502 may be realized as a value between 0 and 1 that is normalized based on a comparison with the valuation data of other septic systems in the area. Inspection value 500 may be positively impacted by a system that has been given a high valuation by one or more professionals. Valuation data 502 may be manually entered or retrieved from inspection records or installation reports for a given septic system.

Inspection dates 504 represents a number of times inspections have been performed for the septic system, or a frequency in which inspections are performed, according to some embodiments. A system that has not been inspected for a given period of time may negatively impact inspection value 500. According to some embodiments, inspection dates 504 is provided as a value between 0 and 1 that is normalized based on a comparison with the inspection rates of other septic systems in the area. Inspection dates 504 may be manually entered or retrieved from inspection records for a given septic system.

Inspector rating 506 represents ratings or any other quantitative evaluations of any of the inspectors of the septic system, according to some embodiments. A low-rated inspector may negatively impact the inspection value 500. According to some embodiments, inspector rating 506 is provided as a value between 0 and 1 that is normalized based on a comparison with the ratings or evaluations of other local inspectors. Inspector rating 506 may be manually entered or retrieved from online sources that store such ratings.

Regulatory information 508 represents any quantitative regulatory data with regards to the septic system, according to some embodiments. Such data may represent a measure of how well the septic system adheres to regulatory guidance issued by the environmental protection agency (EPA). According to some embodiments, regulatory information 508 is provided as a value between 0 and 1 that is normalized based on a comparison with how well other septic systems in the same area adhere to regulatory guidance. Regulatory information 508 may be manually entered or retrieved from inspection or installation records for the septic system.

Inspection photos 510 represents any quantitative information that can be gleaned from photographs taken of the septic system, according to some embodiments. In some examples, image processing techniques can be used to identify structural issues with the septic system or other warning signs with regards to the location of the septic system (such as being too close to a tree). According to some embodiments, inspection photos 510 is provided as a value between 0 and 1 based on the severity of the warning signs observed in the photos. Convolution neural networks (CNN) or other types of deep learning networks can be used to automatically detect salient features from the photos that indicate potential problems with the septic system. In some embodiments, inspection photos 510 can be retrieved from inspection or installation records for the septic system.

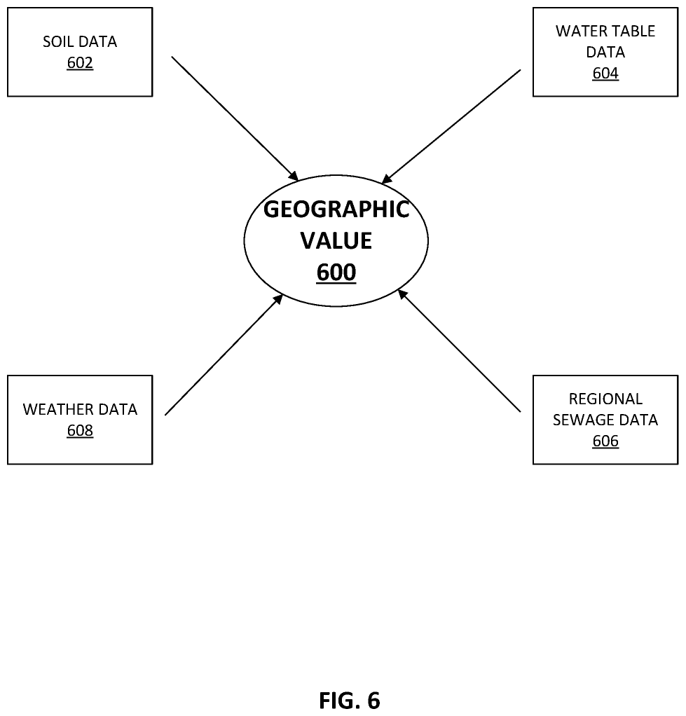

FIG. 6 illustrates a flowchart for determining a geographic value 600, which represents the category value attributed to the geographic/environmental data category 208. Geographic value 600 is generated based on a variety of different septic system inspection variables. Example septic system geographic variables include soil data 602, water table data 604, regional sewage data 606, and weather data 608. It should be understood that any number of septic system geographic variables can be collected to determine geographic value 600. According to some embodiments, any of the septic system geographic variables are used to train or update a neural network model configured to generate a septic system score.

Soil data 602 represents data associated with measurable characteristics of the soil around any parts of the septic system, according to some embodiments. The chemical composition and morphology of the soil can provide insight into the overall health or projected lifespan of the septic system. Some examples of soil data to be evaluated include pH levels, nitrogen levels, soil composition, percolation rate, or presence of roots close to the septic system. According to some embodiments, soil data 602 can include different values for each variable that are normalized to a value between 0 and 1 based on a comparison with the soil data from other septic systems in the area. Soil data 602 may be manually entered or retrieved from contractor records (from contractors that perform soil testing), town records, or EPA reports for a given septic system. More generally, soil data 602 can be obtained from any municipal, federal, governmental, or academic reports or records, or from data collected by an NGO or private sector company. In some embodiments, sensors affixed to the septic system or near the septic system can provide any part of soil data 602.

Water table data 604 represents data associated with measurable characteristics of the water table in the same region as the septic system, according to some embodiments. Water table data 604 may include data associated with a depth of the water table beneath the ground surface in the region or the surface topography of the water table. According to some embodiments, water table data 604 can include different values for each variable that are normalized to a value between 0 and 1. Water table data 604 may be manually entered or retrieved from town records or EPA reports for a given region. More generally, water table data 604 can be obtained from any municipal, federal, governmental, or academic reports or records, or from data collected by an NGO or private sector company. In some embodiments, sensors affixed to the septic system or near the septic system can provide any part of water table data 604.

Regional sewage data 606 represents data associated with measurable characteristics of the sewage infrastructure in the region around the septic system, according to some embodiments. Regions with good and efficient sewage infrastructure may positively impact the geographic value 600. According to some embodiments, regional sewage data 606 can include a quantitative metric of the general goodness of the infrastructure on a scale between 0 and 1 based on a comparison with the regional sewage data from other regions. Regional sewage data 606 may be manually entered or retrieved from town records or EPA reports for a given region. More generally, regional sewage data 606 can be obtained from any municipal, federal, governmental, or academic reports or records, or from data collected by an NGO or private sector company.

Weather data 608 represents data associated with measurable characteristics of weather patterns in a same region as the septic system, according to some embodiments. Weather data 608 may include data associated with how often it rains, how much it rains, average wind speed, or how often the ground freezes, to name a few examples. According to some embodiments, weather data 608 can include different values for each variable that are normalized to a value between 0 and 1 based on a comparison with weather data from other regions. Weather data 608 may be manually entered or retrieved from town records or online sources that store weather information for a given region. More generally, weather data 608 can be obtained from any municipal, federal, governmental, or academic reports or records, or from data collected by an NGO or private sector company.

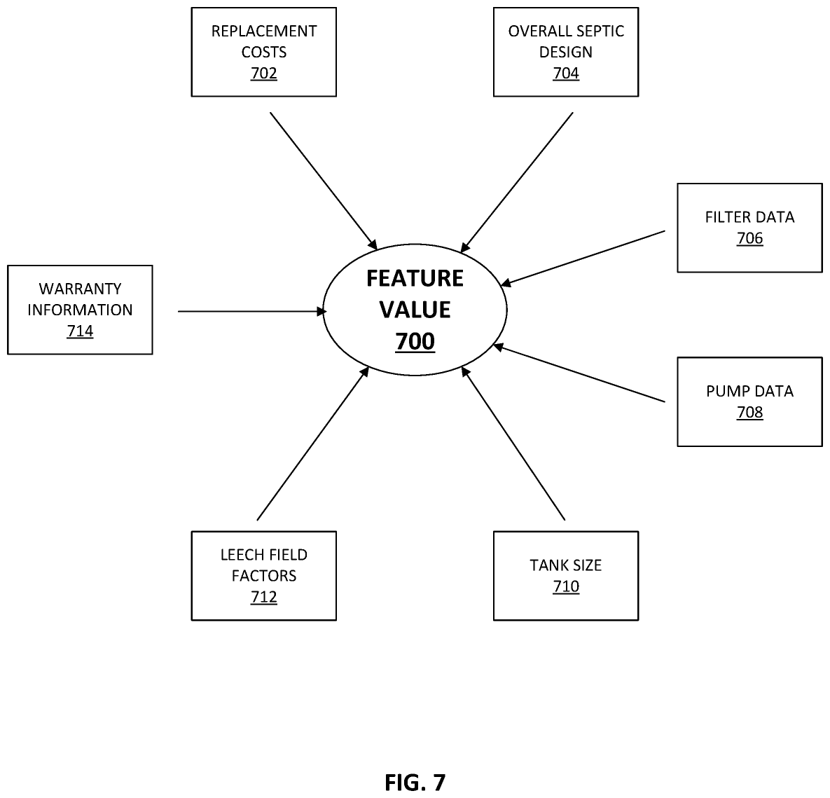

FIG. 7 illustrates a flowchart for determining a feature value 700, which represents the category value attributed to the system features category 210. Feature value 700 is generated based on a variety of different septic system features. Example septic system features include replacement costs 702, system design 704, filter data 706, pump data 708, tank size 710, leach field factors 712, and warranty information 714. It should be understood that any number of septic system feature variables can be collected to determine feature value 700. According to some embodiments, any of the septic system feature variables are used to train or update a neural network model configured to generate a septic system score.

Replacement costs 702 represents expected costs to replace or repair any of the components of the septic system, according to some embodiments. High replacement costs can negatively impact the feature value 700. According to some embodiments, replacement costs 702 is provided as a value between 0 and 1 that is normalized based on a comparison with the replacement costs of other septic systems in the area. Replacement costs 702 may be manually entered or retrieved from contractor records (from replacements performed for similar systems) or from inventory records of parts distributors and retailers. More generally, replacement costs 702 can be obtained from any municipal, federal, governmental, or academic reports or records, or from data collected by an NGO or private sector company.

System design 704 represents any quantifiable aspects regarding the overall design of the septic system, according to some embodiments. System design 704 may be realized as a value between 0 and 1 that is normalized based on a comparison with the system designs of other septic systems in the area. Some designs may be better suited than others depending on how much usage the septic system gets on a daily basis. Some example septic system designs include a conventional system (with gravel leach filed), a chamber system (no gravel in the leach field), a drip distribution system, an aerobic treatment unit, a mound system, a recirculating sand filter system, or an evapotranspiration system. A system design that is better matched with the local environment and structure may have a positive impact on feature value 700. System design 704 may be manually entered or retrieved from inspection records or installation reports for a given septic system. More generally, system design 704 can be obtained from data collected by any NGO or private sector company.

Filter data 706 represents any quantifiable aspects of the filtering ability of the septic system, according to some embodiments. Systems that have a high filter rate (rate of removal) may positively impact feature value 700. According to some embodiments, filter data 706 is provided as a value between 0 and 1 that is normalized based on a comparison with the filter data of other septic systems in the area. Filter data 706 may be manually entered or retrieved from inspection reports or manufacturer records. More generally, filter data 706 can be obtained from data collected by any NGO or private sector company. In some embodiments, sensors affixed to the septic system or near the septic system can provide any part of filter data 706.

Pump data 708 represents any quantifiable aspects of the pumping ability (if present) of the septic system, according to some embodiments. Systems that have a high pump rate compared to system capacity may positively impact feature value 700. According to some embodiments, pump data 708 is provided as a value between 0 and 1 that is normalized based on a comparison with the pump data of other septic systems in the area. Pump data 708 may be manually entered or retrieved from inspection reports or manufacturer records. More generally, pump data 708 can be obtained from data collected by any NGO or private sector company. In some embodiments, sensors affixed to the septic system or near the septic system can provide any part of pump data 708.

Tank size 710 represents the chamber volume of the septic system and is associated with a retention time of wastewater within the septic system, according to some embodiments. Systems that have a sufficiently large tank size 710 based on expected usage may positively impact feature value 700. Tank size 710 may be manually entered or retrieved from inspection reports or manufacturer records. More generally, tank size 710 can be obtained from data collected by any NGO or private sector company.

Leach field factors 712 represents any quantifiable aspects of the septic system's leach field or drainage field, according to some embodiments. Some example leach field factors include relative size of the leach field to the size of the dwelling, depth of the leach field, or gravel size/type. According to some embodiments, leach field factors 712 can include different values for each variable that are normalized to a value between 0 and 1 based on a comparison with leach field factors from other septic systems in the region. Leach field factors 712 may be manually entered or retrieved from inspection reports or manufacturer records. More generally, leach field factors 712 can be obtained from data collected by any NGO or private sector company. In some embodiments, sensors affixed near the leach field can provide any part of leach field factors 712.

Warranty information 714 represents a quantitative measure of how much longer the septic system is protected under some kind of warranty, from either the installer or manufacturer, according to some embodiments. Systems that are protected under a long-term warranty may have a positive impact on feature value 700. According to some embodiments, warranty information 714 is provided as a value between 0 and 1 that is normalized based on a comparison with the warranty information of other septic systems in the area. Warranty information 714 may be manually entered or retrieved from installation reports or manufacturer records.

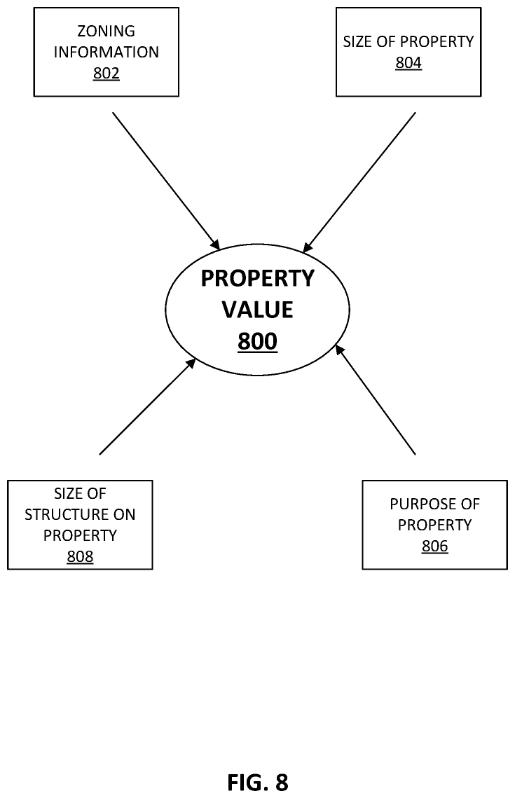

FIG. 8 illustrates a flowchart for determining a property value 800, which represents the category value attributed to the property data category 212. Property value 800 is generated based on a variety of different property variables. Example property variables include zoning information 802, property size 804, property purpose 806, and structure size 808. It should be understood that any number of property variables can be collected to determine property value 800. According to some embodiments, any of the septic system property variables are used to train or update a neural network model configured to generate a septic system score.

Zoning information 802 represents data associated with measurable characteristics of the type of property zone that the septic system is in, according to some embodiments. Some systems may historically fare better than others depending on the property's zoning classification. According to some embodiments, zoning information 802 can include a quantitative metric of the general goodness of the zone compared to other zoning types on a scale between 0 and 1. Zoning information 802 may be manually entered or retrieved from town records or installation reports for a given septic system. More generally, zoning information 802 can be obtained from any municipal, federal, governmental, or academic reports or records, or from data collected by an NGO or private sector company.

Property size 804 represents a relative size of the property that is coupled to the septic system, according to some embodiments. According to some embodiments, property size 804 is provided as a value between 0 and 1 that is normalized based on a comparison with the property sizes of other similar septic systems in the area. Property size 804 may be manually entered or retrieved from installation reports or town records. More generally, property size 804 can be obtained from any municipal, federal, governmental, or academic reports or records, or from data collected by an NGO or private sector company.

Property purpose 806 represents how the property is being used, according to some embodiments. For example, some properties may have a business operating on the property while other properties may include one or more mobile homes on the property. These factors can have an impact on the property value 800 based on historical knowledge regarding how septic systems fare on such properties. Property purpose 806 may be manually entered or retrieved from installation reports or town records. More generally, property purpose 806 can be obtained from any municipal, federal, governmental, or academic reports or records, or from data collected by an NGO or private sector company.

Structure size 808 represents a relative size of the structure that is coupled to the septic system, according to some embodiments. A larger structure is expected to require more usage from the septic system, and thus a larger system is expected for larger structures. According to some embodiments, structure size 808 is provided as a value between 0 and 1 that is normalized based on a comparison with the structure sizes of other similar septic systems in the area. Structure size 808 may be manually entered or retrieved from installation reports or town records. More generally, structure size 808 can be obtained from any municipal, federal, governmental, or academic reports or records, or from data collected by an NGO or private sector company.

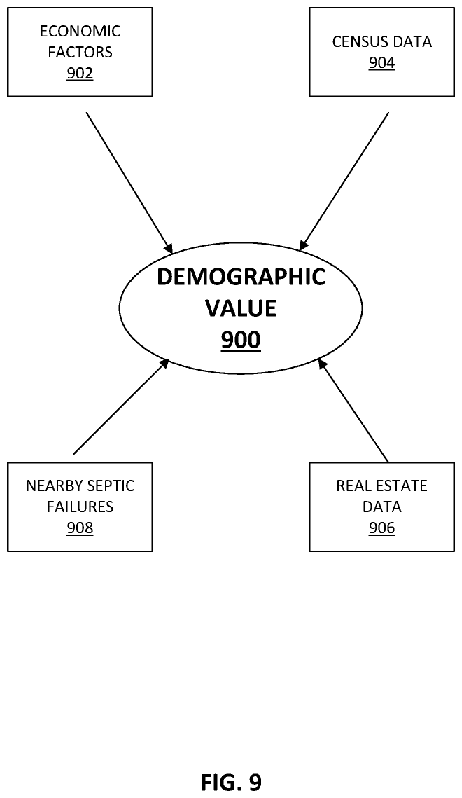

FIG. 9 illustrates a flowchart for determining a demographic value 900, which represents the category value attributed to the socio-demographic data category 214. Demographic value 900 is generated based on a variety of different demographic variables. Example demographic variables include economic factors 902, census data 904, real estate data 906, and nearby septic failures 908. It should be understood that any number of demographic variables can be collected to determine demographic value 900. According to some embodiments, any of the septic system demographic variables are used to train or update a neural network model configured to generate a septic system score.

Economic factors 902 represents data associated with measurable characteristics of the local economy in the region where the septic system is, according to some embodiments. Some economic factors are historically shown to predict the quality and/or longevity of septic systems. According to some embodiments, economic factors 902 can include a quantitative metric of the general impact the local economy has on the septic system on a scale between 0 and 1. Economic factors 902 may be manually entered or retrieved from town records or online economic reports for a given region. More generally, economic factors 902 can be obtained from any municipal, federal, governmental, or academic reports or records, or from data collected by an NGO or private sector company.

Census data 904 represents data gleaned from a population census, according to some embodiments. The Census data can provide insight into certain factors, such as population density of a given region or how fast a region is growing. According to some embodiments, census data 904 can include a quantitative metric of the general impact the local population density or population growth rate has on the septic system on a scale between 0 and 1. Census data 904 may be manually entered or retrieved from town records or online census reports for a given region. More generally, census data 904 can be obtained from any municipal, federal, governmental, or academic reports or records, or from data collected by an NGO or private sector company.

Real estate data 906 represents data associated with measurable characteristics of the real estate growth for the region that the septic system is in, according to some embodiments. Regions showing real estate growth that is too fast may have a negative impact on the demographic value 900. According to some embodiments, real estate data 906 is provided as a value between 0 and 1 that is normalized based on a comparison with the real estate growth of other regions with similar septic systems in the area. Real estate data 906 may be manually entered or retrieved from town records or online relator reports for a given region. More generally, real estate data 906 can be obtained from any municipal, federal, governmental, or academic reports or records, or from data collected by an NGO or private sector company.

Nearby septic failures 908 represents data associated with a total number of, or relative number of, other septic system failures in the same region as a given septic system, according to some embodiments. Regions with a high number of nearby septic system failures may result in a negative impact to demographic value 900 for the septic systems of those regions. According to some embodiments, nearby septic failures 908 is provided as a value between 0 and 1 that is normalized based on a comparison with the number of failures identified in other regions with similar septic systems in the area. Nearby septic failures 908 may be manually entered or retrieved from contractor records for a given region. More generally, nearby septic failures 908 can be obtained from any municipal, federal, governmental, or academic reports or records, or from data collected by an NGO or private sector company.

The performance and longevity of a given septic system may be reflected in the septic system score for that system, and these qualities may be influenced by technological advancements, maintenance practices, environmental conditions, and regulatory standards. Furthermore, several of the parameters used to determine the septic system score are interconnected, such that they can influence each other in various ways. For example, a system designed for dense soils with a high bacterial concentration (BOD) level will require a larger footprint (due to lower soil permeability) and increased retention capacity to ensure adequate treatment. Conversely, systems in areas with less dense soil and lower BOD levels can be smaller and less complex, potentially increasing their lifespan and reducing maintenance requirements. Negative aspects in one area (e.g., high BOD levels) could be mitigated by positive aspects in another (e.g., high retention capacity), according to some embodiments.

To give an example, septic system A and septic system B may be two different septic systems for homes in the same neighborhood. The category values in Table 1 below may be determined for each septic system after collecting and weighting the variables discussed above. The values are provided on a scale of 0-100 for ease of discussion, but may be used on any common scale.

TABLE 1

| | | | | | | | Socio- |
|---|---|---|---|---|---|---|---|
| | Histor- | Sam- | Inspec- | Environ- | Fea- | Prop- | Demo- |
| | ical | ple | tion | mental | tures | erty | graphic |
| System A | 95 | 90 | 99 | 70 | 90 | 80 | 93 |
| System B | 50 | 80 | 75 | 70 | 65 | 82 | 93 |

In this example scenario, septic system A may be a newer system that was installed only a few years prior to replace the older system, while septic system B is original to the home and is decades old. Accordingly, the various category values can reflect these facts. For example, the property, socio-demographic, and environmental categories all provide roughly the same values for the two systems since they are in the same general location (e.g., same neighborhood), and may be coupled to similar-sized homes. However, septic system A has noticeably higher historical, inspection, and feature values due to it being a newer and more technologically advanced system compared to septic system B.

In this example scenario, the final septic system score for septic system A would be higher than the final septic system score for septic system A. How much higher the score is may depend on how the various category values are weighted. For example, if a category like environmental data or property data is heavily weighted compared to other categories, then the septic system score for system A may only be slightly higher than the septic system score for system B since the two systems had very similar values for these categories. However, if a category like historical data, inspection data, or feature data is heavily weighted compared to other categories, then the septic system score for system A may be much higher than the septic system score for system B since septic system A and much higher values than septic system B for these categories.

### Methodology

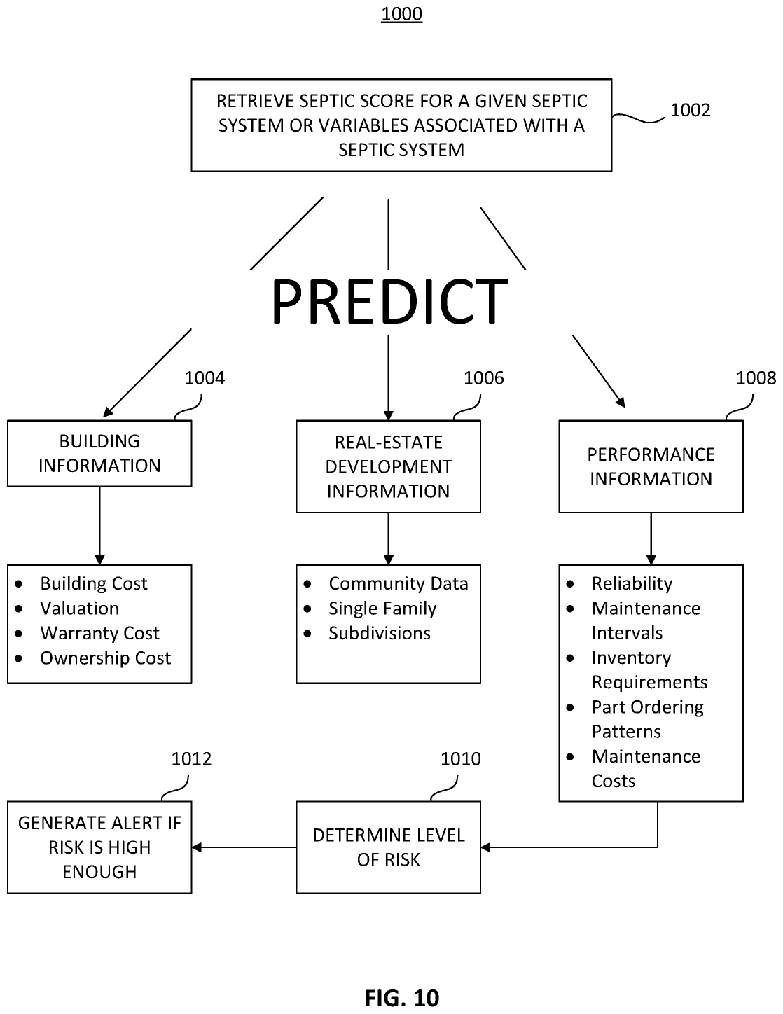

FIG. 10 illustrates a flowchart 1000 that describes a method for using a septic system score and/or one or more septic system variables to make predictions regarding the septic system and the surrounding region, according to some embodiments. Furthermore, based on the septic system score and/or any of the variables used to generate the score, a level of risk can be calculated associated with the septic system. Alerts can be generated for the user based on the level of risk. The operations, functions, or actions described in the respective blocks of flowchart 1000 may be stored as computer-executable instructions in a non-transitory computer-readable medium, such as a memory and/or a data storage of a computing system. In some embodiments, the operations of the various blocks of flowchart 1000 are performed by prediction module 122.

At block 1002, a pre-generated septic system score is retrieved for a given septic system, according to some embodiments. In some embodiments, particular septic system variables are retrieved from one or more stored databases or are received via manual user input. These variables and/or septic score may be accessed in order to provide predictions regarding any number of different factors related to the septic system, the building attached to the septic system, or the general region. For example, a user may enter a type of septic system along with its size and average daily use in order to predict the expected life expectancy of the septic system and an estimated cost of maintenance for the septic system. Many other predictions can be made as well and presented to the user via a GUI or any display device.

In one such example, at block 1004, the septic system score and/or any septic system variables are used to predict building information for the septic system, according to some embodiments. The building information includes factors such as, for example, predicted cost to install the septic system, predicted valuation of the septic system, predicted warranty or ownership costs, etc. The predicted building information can be provided to a user via a GUI or display upon receiving manually entered septic system variables or a septic system score. In some embodiments, the predicted building information also factors in quotes provided by local contractors for other similar septic systems in the region.

In another example, at block 1006, the septic system score and/or any septic system variables are used to predict real-estate development information, according to some embodiments. Some examples of the predicted data include predicting the best or most cost-effective septic systems to use for a given community, given single family home, or a given subdivision. According to some embodiments, property data variables, socio-demographic data variables, and geographic/environmental data variables are entered or retrieved in order to predict a type of septic system to use for the given region. The predictions may provide different septic system options, such as an overall best system (e.g., highest septic system score), a system with a lowest footprint, a system that is least expensive, or a system that is most commonly used in other similar regions, to name a few examples.

In another example, at block 1008, the septic system score and/or any septic system variables are used to predict performance information for a given septic system, according to some embodiments. Some examples of performance information include system reliability, predicted maintenance intervals, inventory requirements, predicted part ordering, or predicted maintenance costs. Such predictions may be especially useful for a contractor or other maintenance provider to determine how likely a given septic system will need to be serviced in the future and what parts it would most likely need. Furthermore, homeowners or other users of a given septic system can input certain known variables about the system to determine when it may next need to be serviced and/or the predicted costs involved.

At block 1010, a risk level is determined with regards to the septic system based at least on one or more of the performance-related predictions, according to an embodiment. As discussed above, the performance predictions are based on many of the weighted septic system variables associated with the feature data and historical data of the septic system. According to some embodiments, at least two different weighted variables are selected and used to determine a risk level. The weighted variables may come from any one of the different data categories used to generate the septic system score. Some variables are more heavily weighted with regards to the risk determination. For example, a septic system's age may have a large impact on the risk with very old systems carrying an intrinsically higher risk. The risk level can be stored in a database that also stores risk levels for any number of other different septic systems.

At block 1012, an alert is generated if the risk level is found to be above a threshold value. The alert may be provided on a display to the user along with the septic system score for the given septic system. The alert may involve a message that provides why the risk is determined to be high (e.g., providing values for the variables that heavily impacted the risk assessment). The alert may involve any graphical indications, such as, for example, flashing the septic system score to alert the user that there is a high-risk situation with the given septic system.

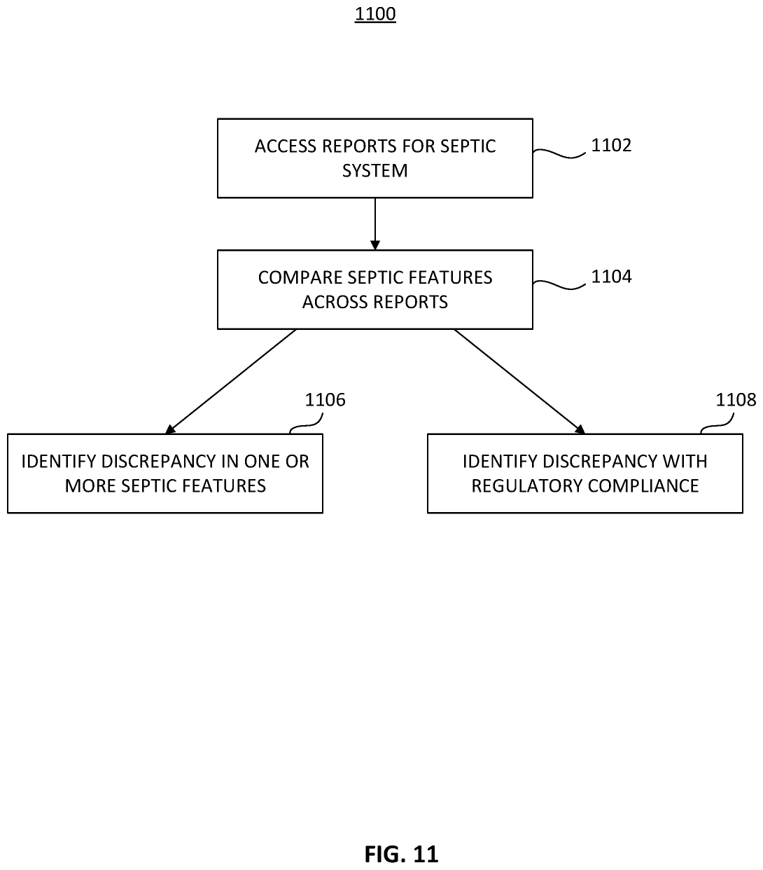

FIG. 11 illustrates an example method 1100 of identifying discrepancies in septic system reports, according to an embodiment. The operations, functions, or actions described in the respective blocks of example method 1100 may be stored as computer-executable instructions in a non-transitory computer-readable medium, such as a memory and/or a data storage of a computing system. In some embodiments, the operations of the various blocks of method 1100 are performed by septic scoring platform 116. As will be further appreciated in light of this disclosure, for this and other processes and methods disclosed herein, the functions performed in method 1100 may be implemented in a differing order. Additionally, or alternatively, two or more operations may be performed at the same time or otherwise in an overlapping contemporaneous fashion.

Method 1100 begins at block 1102 where various septic system reports or records are accessed. The reports and/or records may be stored in a networked database that contains records and/or reports for many different septic systems. A new report or record can be generated each time the septic system is inspected, maintained, or has work done on it. Additionally, there may be installation reports or regulatory-based reports associated with the septic system.

At block 1104, features across the various reports associated with a septic system are compared to one another. The features may involve any aspects of the septic system, such as important dates or physical parameters of the septic system. The important features in the documents may be identified using any natural language detection techniques along with text identification techniques, such as optical character recognition (OCR).

At block 1106, discrepancies between any of the features between different septic system documents are identified based on the comparison performed in block 1104. For example, if the installation date of a septic system is different on two different reports, then this discrepancy would be identified. In some embodiments, the severity of the discrepancy may also be identified in some fashion (e.g., based on a scale from 1 to 5 or 1 to 10). In some embodiments, identified discrepancies can be presented to a user by showing a graphic of the reports that have the discrepancy along with a highlight or other indicator of where the discrepancy is in the reports. Different colors may be used to designate the severity level of the discrepancy. According to some embodiments, any identified discrepancies between reports and/or records are flagged and stored in a database for easy retrieval at a later date.

At block 1108, discrepancies with regulatory compliance are identified based on the identified features from any of the septic system records and/or reports. For example, if the septic system is determined to be too close to another structure, against regulations, then this feature would be identified in the corresponding report. In some embodiments, the severity of the compliance discrepancy may also be identified in some fashion (e.g., based on a scale from 1 to 5 or 1 to 10). In some embodiments, identified regulatory compliance discrepancies can be presented to a user by showing a graphic of any reports that have the discrepancy along with a highlight or other indicator of where the discrepancy is in the reports. Different colors may be used to designate the severity level of the discrepancy. According to some embodiments, any identified discrepancies with regulatory requirements are flagged and stored in a database for easy retrieval at a later date.

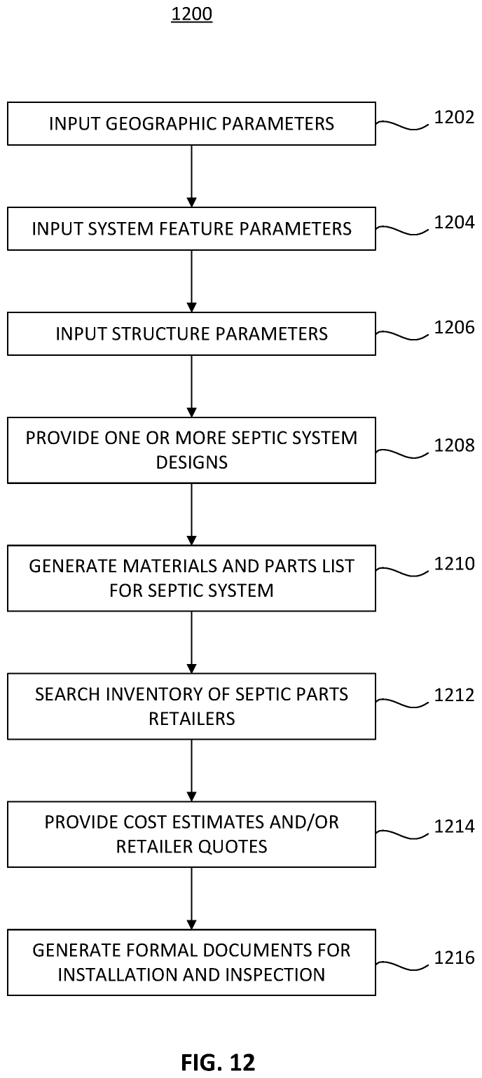

FIG. 12 illustrates an example method 1200 of creating a septic system design based on inputted septic system variables, according to an embodiment. The operations, functions, or actions described in the respective blocks of example method 1200 may be stored as computer-executable instructions in a non-transitory computer-readable medium, such as a memory and/or a data storage of a computing system. In some embodiments, the operations of the various blocks of method 1200 are performed by septic design module 124. As will be further appreciated in light of this disclosure, for this and other processes and methods disclosed herein, the functions performed in method 1200 may be implemented in a differing order. Additionally, or alternatively, two or more operations may be performed at the same time or otherwise in an overlapping contemporaneous fashion. In general, method 1200 describes an example process in which a user can input desired septic system parameters and receive recommended septic system designs based on the entered parameters. Additionally, any of the recommended designs may include further details such as expected costs, parts needed, and local contractors or retailers that can provide the parts or perform installation of the system.

At block 1202, any number of different geographic parameters are inputted by a user. The parameters may be inputted via a GUI or by any other similar means. Some example geographic parameters that could be inputted include soil data, water table data, weather data, and/or location data. According to some embodiments, other data can be retrieved based on some of the entered parameters. For example, based on a received location for the septic system, regulatory requirements can be retrieved from an online source for the given location.

At block 1204, any number of system feature parameters are inputted by a user. The system feature parameters may be physical features or properties of the septic system, such as desired flow rates, pump rates, tank sizes, or leach field variables. The parameters may be inputted via a GUI or by any other similar means.

At block 1206, any number of structure parameters are inputted by a user. The structure parameters may be physical features or properties of the structure connected to the desired septic system. Examples of structure parameters include a size of the structure (e.g., square footage), a number of occupants in the structure, age of occupants in the structure, a number of bedrooms in the structure, a number of bathrooms in the structure, presence of drains in garage or basement, or structure type (e.g., mobile home, single family home, etc.) The parameters may be inputted via a GUI or by any other similar means.

At block 1208, one or more septic system designs are provided to a user based at least one or more of the variables entered by a user in blocks 1202-1206. For each of the design options, at least the overall size of the septic system and the type of septic system is determined by the septic design module 124. According to some embodiments, multiple different septic system designs are provided with each design having a different advantage. For example, one provided design may have the best overall value (e.g., highest septic system score), another design may have the lowest overall footprint, another design may be the most cost effective, another design may have the longest life expectancy, etc. A user can then select one of the provided designs. In some embodiments, a user can select multiple designs to compare the designs to one another during the proceeding operations.

At block 1210, a materials list and/or parts list is generated for the selected septic system design or designs. In some embodiments, the materials/parts list provides all materials and/or parts needed to build the selected septic system(s) that satisfies the entered parameters. The materials/parts list can be displayed to a user for each of the selected septic systems.

At block 1212, the inventory of one or more local retailers or distributers is searched to determine if the materials and/or parts for the selected septic system(s) are in stock. For example, if a certain concrete material is required to build one of the selected septic system designs, then a list of retailers and/or distributers that have the concrete material available can be provided along with the estimated (or quoted) cost for the material. In some embodiments, any materials or parts that cannot be found from any local retailers or distributers are identified in a separate list. In some embodiments, contact information can be provided for large domestic or international retailers or distributers that may carry the materials and/or parts.

At block 1214, cost estimates and/or installation quotes can be provided for the selected septic system(s). According to some embodiments, a list of local installers can be provided for the selected septic system(s) including price information and contact information for each of the installers. In some embodiments, links to the installers webpages or review pages can also be provided.

At block 1216, formal documents for installation and/or inspection of the septic system(s) can be automatically generated upon a request received from a user. The request may be received via a GUI or any user input device. The generated documents may include variance requests or inspection requests, to name a few examples. According to an embodiment, such generated documents may be sent directly to licensed professionals to perform the work, or saved to a user's local computer, or printed directly from the user interface.

According to some embodiments, centralized sewer data may be used when designing a new septic system. For example, centralized sewer data such as proximity data, density, expansion rate, or regulatory influences may be used to predict when centralized sewage may be made available to a given area. This can very important to city planners, developers, industry professionals, and/or consumers as properties within proximity to the centralized sewer system may be required to hook up with it for a given connection fee. Thus, the presence of the centralized sewer system would make the septic system obsolete.

According to some embodiments, knowing when or if a centralized sewer system is being provided to a given area could influence the decision of what type of septic system to install. For example, if the centralized sewer system will be provided within a given timeframe (e.g., within 5 years or within 10 years), then a less expensive septic system may be a better choice, or a design that works better in the short term. The system may recommend that the user asks for variances to septic regulatory requirements (for example, a variance from a regulatory requirement of installing a more advanced (and expensive) nitrogen reducing system since the systems will very likely be temporary). In other examples, a new location of a planned development may be suggested by the system in light of the centralized sewer data, which may predict that centralized sewage will be provided to some areas before other areas.

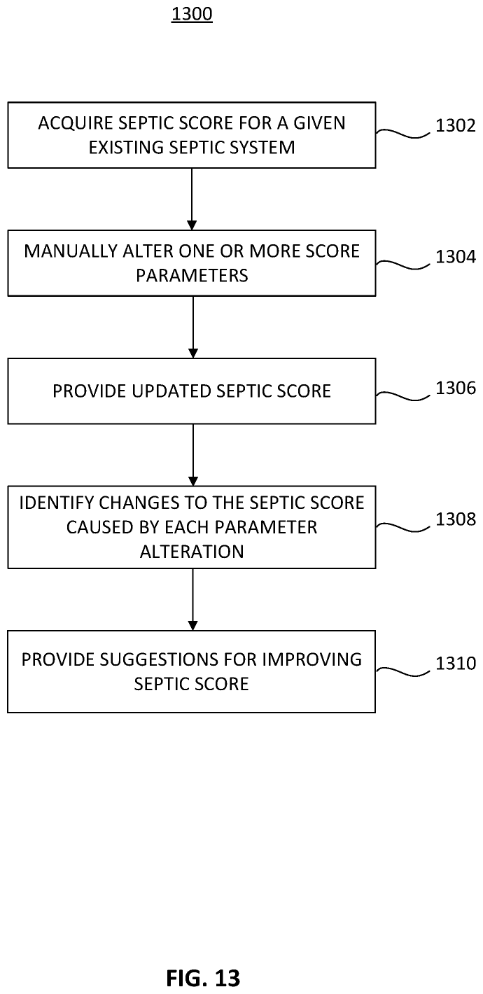

FIG. 13 illustrates an example method 1300 of simulating a septic system score based on different septic system variables, according to an embodiment. The operations, functions, or actions described in the respective blocks of example method 1300 may be stored as computer-executable instructions in a non-transitory computer-readable medium, such as a memory and/or a data storage of a computing system. In some embodiments, the operations of the various blocks of method 1300 are performed by septic score simulator 126. As will be further appreciated in light of this disclosure, for this and other processes and methods disclosed herein, the functions performed in method 1300 may be implemented in a differing order. Additionally, or alternatively, two or more operations may be performed at the same time or otherwise in an overlapping contemporaneous fashion. In general, method 1300 describes an example process in which a user can see in real time how changing certain septic system variables alters the septic system score. Additionally, suggestions can be provided for raising a septic system score along with showing how much the score would change if certain changes were made to the septic system or its maintenance.

Method 1300 begins at block 1302 where a septic system score is acquired for a given septic system. According to some embodiments, the septic system score may be acquired from a database that contains scores for multiple different septic systems of a given region. In one example, the septic system score is acquired based on a home or business address that is manually inputted by a user, such that the septic system score for the septic system at that home or business address is accessed. In some embodiments, a septic system score is generated by a user entering one or more parameters related to the septic system, such as any of the septic system variables discussed with reference to FIGS. 3-9. Some of the parameters may be automatically retrieved for a given septic system based on its location and/or inspection details to provide the septic system score for the system. In some embodiments, the user can be prompted to fill in any missing parameters or variables needed to complete the septic system score for a given septic system.

At block 1304, input is received from a user to change one or more of the septic system score parameters. According to some embodiments, any of the septic system variables discussed with reference to FIGS. 3-9 can be changed by a user to see the effects to the septic system score. For example, the user may change how often a given septic system is to be pumped or inspected to see how this change will affect the septic system score. Multiple variables can be changed to view the changes to the septic system score in real time. For example, the user may change parameters related to the soil around the septic system as well as the gravel type used in the leach field to see what affect both changes have on the septic system score.

At block 1306, the updated septic system score is provided. According to some embodiments, the user may click or touch a button to “update” the score after making changes to certain parameters and the updated score is provided in response to the button being clicked or touched. The updated score may be provided in a way that illustrates how much it changed from the previous score. For example, if the septic system score raises due to the changed parameters, then the new score may be provided in a green color with an upward arrow near it showing that the score has increased due to the changes. In another example, if the septic system score lowers due to the changed parameters, then the new score may be provided in a red color with an downward arrow near it showing that the score has decreased due to the changes. As will be appreciated, any other graphical indicators can be used to illustrate a degree to which the septic system score changes due to parameter changes.

At block 1308, specific changes to the septic system score are identified for each of the parameter changes. According to some embodiments, the change to the septic system score is broken down for each of the parameter changes to help the user visualize what changes are better than others. For example, if a user makes changes to four different septic system parameters and then recalculates the septic system score, the updated score may be provided along with an indicator associated with each of the changed parameter of what affect that changed parameter had on the final score. Continuing this example, an indicator associated with the first changed parameter may indicate that changing the first parameter raised the septic system score by 3 points; an indicator associated with the second changed parameter may indicate that changing the second parameter raised the septic system score by 1 point; an indicator associated with the third changed parameter may indicate that changing the third parameter raised the septic system score by 8 points; and an indicator associated with the fourth changed parameter may indicate that changing the fourth parameter lowered the septic system score by 4 points. Overall, after making the four changes, the septic system score displays a net increase of 8 points, but breaking down the changes shows that 3 of the 4 parameter changes positively affected the score, while the other parameter change negatively affected the score.

At block 1310, one or more suggestions are provided to the user to increase the septic system score. According to some embodiments, septic score simulator 126 runs internal simulations by altering different septic system variables to determine which variables have the greatest impact on the septic system score. Suggestions can be then be provided to the user regarding which variables have the greatest effect on increasing the score. In some embodiments, after receiving a certain septic system score, the user may also be presented with a dialog box or other textual indicator that details ways to increase the septic system score. In some embodiments, a separate button is clicked or pressed by the user to receive the suggestions. For example, after receiving a septic system score, the system may present text or graphics to the user that indicate they can raise their septic system score by x amount if they change parameter y by z. A real-world example includes the system informing the user that the they could raise their septic system score by 10 points if they pumped their system every year.

According to some embodiments, the suggested changes for improving the septic score include suggested local contractors/providers that can perform services that increase the septic system score. Such services may include pumping services, inspection services, repair services, or other types of cleaning/maintenance. The improvement to the septic score can be displayed if the suggested service were to be performed by one of the recommended service providers. If a user decides to use one of the recommended service providers, data regarding their system such as their septic system score and/or any of the septic system parameters can be transmitted to the selected service provider. Proposals from the provider for performing the service can also be displayed to the user, or a link to contact the provider for requested a proposal may be displayed.

According to some embodiments, a user that is proposing a new septic system design, or that is the owner of a septic system, can be matched with one or more service providers (e.g., contractors) for performing any suggested services to the septic system. In some embodiments, users can be matched with contractors to perform any tasks related to the septic system such as installation, inspection, maintenance, or removal. The system may be able to match a given septic system job, or a particular septic system, to one or more local contractors based on various contractor factors that are continually updated in a database as more and more information is collected over time about the contractors. Some example factors used by a machine learning AI (such as a neural network) to generate a match between a septic system job (or the septic system itself) and a contractor include: contractor history, how long the contractor has been in business, number of employees, type of equipment owned by the contractor, contractor experience/expertise with certain types of septic systems, size of the septic system, zoning information for the septic system (e.g., residential, commercial, municipal), whether the septic system is clustered together with others, the application of the septic system (hospital with pharmaceutical implications, coffee shop with high pH, brewery with high bacteria concentration, etc.), type of septic technology (pipe-and-stone, mechanical treatment systems, passive sand based technology, disinfection, phosphorus/nitrogen removal, reuse, pressurized systems, low pressure systems, control panels, pump curve data, above grade systems, below grade systems, etc.), contractor familiarity with septic site conditions (e.g., soils types, near surface water, tight sites, flood zone, and other climate/environmental considerations such as cold weather or heavy rainfall), or other peripheral factors such as contractor education level or proximity. Any of the noted factors in the list above are contractor factors that can be stored for each service provider within a database. According to some embodiments, the matching process involves correlating common parameters or common parameter values between the contractor factors and any of the septic system variables and/or weighted variables.

Since not all contractors have the same equipment, it can be very important that any contractor matched to a particular job or particular system has the correct equipment to perform the job well or to service the particular system. According to some embodiments, the AI used to perform the matching is constantly being refined and updated based on feedback data associated with customer satisfaction ratings of different contractors, retention rates, customer acquisition cost, lead acceptance rate, contractor response time, marketing insights, etc. to reinforce or change aspects of the AI algorithm.

According to some embodiments, septic system scores are also considered during the matching process. For example, contractors that routinely install or design septic systems that have high septic system scores can be given priority over other contractors. Contractors may be matched to a particular job if they have been known to improve septic systems with similar issues or similar septic system scores, especially if their previous work raised the septic system scores of the previous septic systems that they serviced. According to some embodiments, septic system variables associated with the environment (such as any of the variables discussed with reference to FIG. 6), and/or weighted versions of the variables, are correlated with contractor factors (such as any of the contractor factors noted above) to determine one or more contractors that are a good match for handling a septic system in a given environment. According to some embodiments, a negative filtration process is performed where contractors that are found to be a bad match for a given septic system or septic system job are removed from consideration, and only the contractors that remain are provided as matches. According to some embodiments, a contractor may be matched to a particular septic system job that is found to most likely provide the highest septic system score for the given septic system. In some other examples, a contractor that provides the best value or has the highest customer satisfaction ratings can be chosen for a particular job. In some embodiments, multiple different contractors can be matched to a job and provided to a user to select one of the contractors. The list of contractors can also include a top reason why the particular contractor was matched to the job (e.g., provides highest predicted septic system score, provides best value, has highest customer satisfaction ratings, etc.)

It should be noted that the techniques used to match contractors with a given septic system or proposed septic system can be used in any context related to the septic system or proposed septic system. Thus, according to some embodiments, contractors can be matched to a given septic system or septic system job when designing a new septic system or when determining a septic system score for a given septic system or a proposed septic system. In some embodiments, contractors that are matched to a particular septic system or job involving a particular septic system can be provided when updating certain septic system variables to influence the septic system score or simulating a septic system score by changing certain septic system variables. For example, changing the septic system score by updating how often a given septic system is to be pumped causes a list of one or more contractors matched to the particular septic system to be provided that can perform the pumping maintenance.

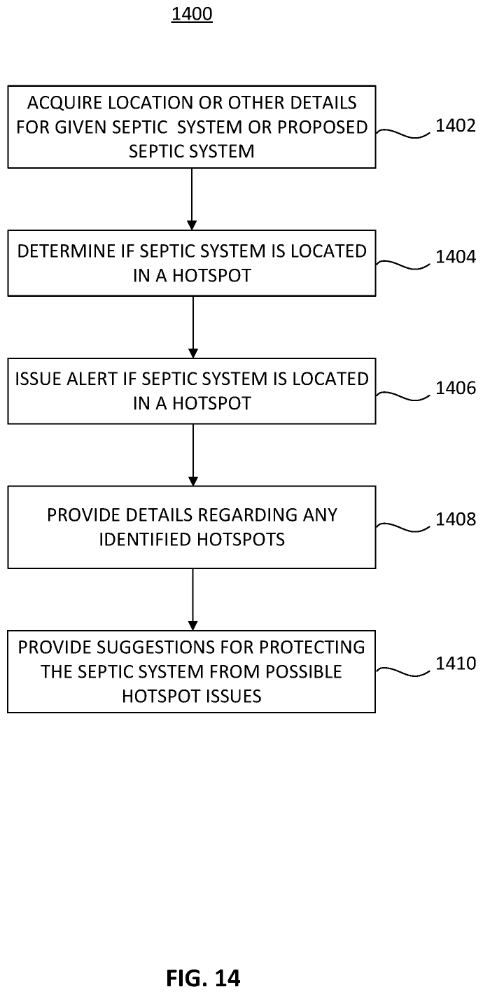

FIG. 14 illustrates an example method 1400 of determining whether a septic system is located in a hotspot and issuing alerts about any potential hotspots, according to an embodiment. A hotspot may be an area (or certain sets of conditions) that is known to have poor septic system reliability or a high failure rate. The operations, functions, or actions described in the respective blocks of example method 1400 may be stored as computer-executable instructions in a non-transitory computer-readable medium, such as a memory and/or a data storage of a computing system. In some embodiments, the operations of the various blocks of method 1400 are performed by prediction module 122 although any other component of septic scoring platform 116 may be used as well. As will be further appreciated in light of this disclosure, for this and other processes and methods disclosed herein, the functions performed in method 1400 may be implemented in a differing order. Additionally, or alternatively, two or more operations may be performed at the same time or otherwise in an overlapping contemporaneous fashion.

Method 1400 begins at block 1402 where the location and/or other parameters for a septic system, or a proposed septic system, are received. For example, the location of a septic system may involve its specific street address or a broader location such as a town or city. Furthermore, the location may be related to land that does not yet have a septic system, but a septic system is being considered to be built on the land. Other septic system parameters may be received as well, such as any of the geographic variables associated with the septic system that can give insight into how robust the septic system might be in light of its surrounding environment. Any of the location or other parameters can be manually entered by a user or retrieved from town records or installation reports for a given septic system or land for a proposed septic system. More generally, the information can be obtained from any municipal, federal, governmental, or academic reports or records, or from data collected by an NGO or private sector company.

At block 1404, a determination is made regarding whether the septic system or proposed septic system is located in a hotspot. The determination may be based on geography. For example, any septic system or proposed system located in particular geographic region may be flagged as being in a hotspot. The region may be designated as a “hotspot” region based on a number of different factors, such as a high failure rate amongst septic systems in the region, poor soil quality in the region, or bad weather patterns in the region, to name a few examples. In some other embodiments, septic systems or proposed septic systems that have certain varibles attributed to them can be flagged as “hotspots”. For example, certain soil quality or other sets of variables can trigger an alert that the septic system is in a hotspot.

At block 1406, an alert is issued to warn that the septic system or proposed septic system is located in a hotspot. According to some embodiments, the alert may be in the form of a graphic displayed on a screen that indicates a given septic system or proposed septic system is located in a hotspot with a prompt to click on the graphic or some other button to learn more about the hotspot. In some embodiments, rather than immediately issuing an alert about a potential hotspot, a graphic or query is presented asking a user if their home/business/etc. is located in a hotspot and to click on the graphic or some other button to find out.

At block 1408, details are provided regarding any identified hotspots associated with the septic system or proposed septic system. For example, if the septic system or proposed system is in a hotspot due to its geographic location, then an indication that the location is in a hotspot may be provided along with a map showing the hotspot region and the septic system location within the hotspot region. In some other examples, certain variables of the septic system or proposed system that flagged the system as being in a hotspot are provided along with an explanation of why the variable(s) caused the system to be in the hotspot. For example, if some variable associated with soil quality is above some hotspot threshold, then the value for that soil variable would be provided along with how much higher (or lower) it was than the hotspot threshold value. Any given septic system or proposed system may be in more than one hotspot, in which case the details for each of the hotspots can be provided either simultaneously or sequentially.

At block 1410, one or more suggestions are provided to help protect the septic system or proposed septic system from the hotspot issues. According to some embodiments, septic score simulator 126 runs internal simulations by altering different septic system variables to determine which variables would have the greatest impact on overcoming any of the hotspot issues. Suggestions can be then be provided to the user regarding which variables have the greatest effect on overcoming a given hotspot problem. In some embodiments, a separate button is clicked or pressed by the user to receive the suggestions. For example, after indicating that the septic system is in a hotspot due to bad soil conditions, the system may present text or graphics to the user that indicate they can overcome the poor soil conditions by changing certain septic system parameters by a certain amount. A real-world example includes the system informing the user that the they could overcome the poor soil conditions if they installed a larger tank or used a larger leach field or a certain type of gravel in the leach field.

### Example GUIs

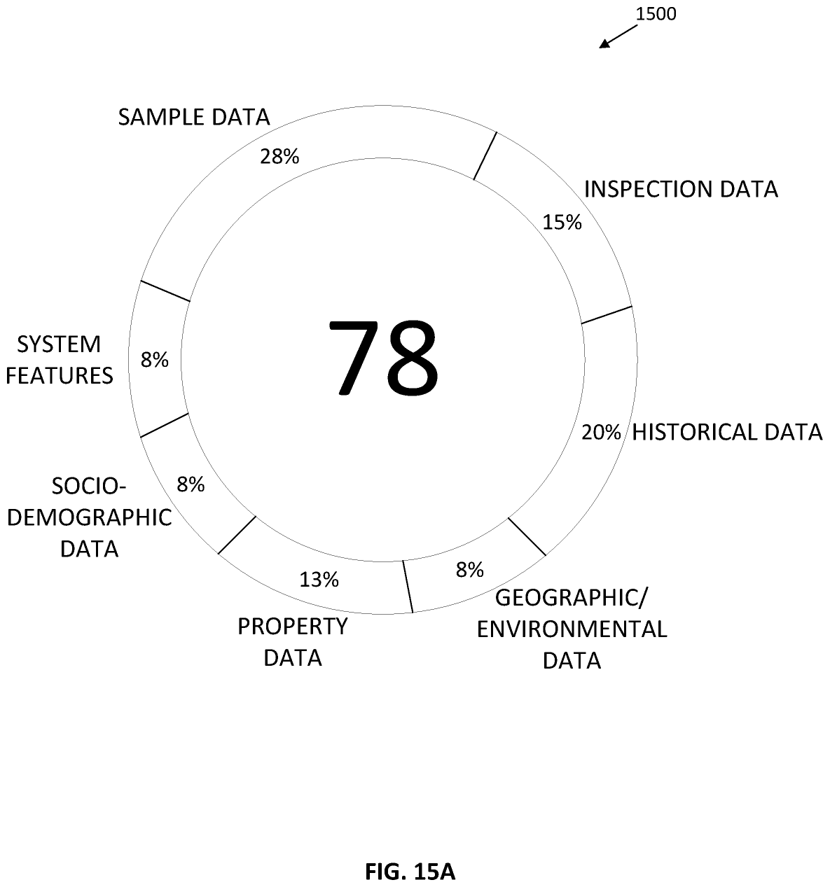

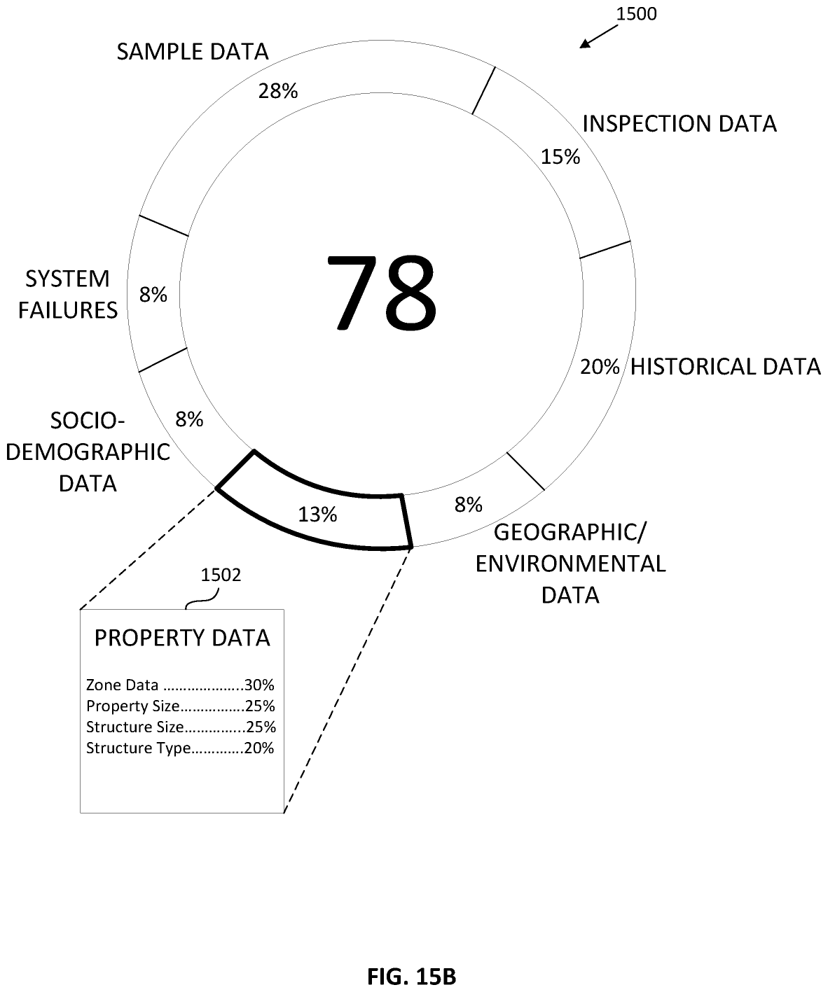

FIG. 15A illustrates an example graphical user interface 1500 used to provide the septic system score on a display, according to some embodiments. The septic system score is provided as a number between 1 and 100, although any other number scale can be used as well. In some other embodiments, the septic system score is provided as a qualitative entity rather than a single number. In some embodiments, the septic system score itself can be a certain color based on its value. For example, scores from 80-100 can be shown with green text or highlighting, scores from 60-80 can be shown with yellow text or highlighting, scores from 50-60 can be shown with orange text or highlighting, and any score below 50 can be shown with red text or highlighting.

According to some embodiments, the septic system score is surrounded by an annular graph (e.g., a ring) made up of segments that correspond to the different data categories used to generate the septic system score. In the illustrated example, there are seven data categories: sample data, inspection data, historical data, geographic/environmental data, property data, socio-demographic data, and system feature data. Additionally, the size of each of the data segments corresponds to the impact the data from that category has on the septic system score. In the illustrated example, the sample data category accounts for 28% of the septic system score while the socio-demographic data only accounts for 8% of the septic system score. The percentages can correspond to the portion of the circumference of the annular graph taken up by the corresponding section. In some embodiments, the size of each of the segments corresponds generally to the weight of that data compared to how much weight is provided to other data categories. In this way, a user can quickly and easily visualize both the septic system score as well as what data has generally had the greatest impact on determining the septic system score. According to some embodiments, changing any parameters that affect the septic system score (such as via the score simulator described with reference to FIG. 13), can also change the size of the different data categories depending on how impactful their data is to the final septic system score.

According to some embodiments, each of the data category segments on the ring can be a different color to further differentiae the segments. The title of each of the segments can also be provided in the segment itself rather than on the outside. In some embodiments, the color of the segment can correspond to how impactful or heavily weighted the data is in determining the septic system score.

FIG. 15B illustrates another view of graphical user interface 1500 where a user has selected one of the segments on the ring around the septic system score to access a more detailed breakdown of the data from the selected data category, according to some embodiments. In the illustrated example, the segment corresponding to the property data category has been selected. The selection can involve clicking or touching the segment on the screen to generate a breakout window 1502. In some other examples, the selection involves moving a mouse cursor over a given segment, which generates breakout window 1502 for as long as the cursor remains over the given segment.

Breakout window 1502 provides a more detailed list of the different septic system variables that were used in the given data category to generate the septic system score. Furthermore, the relative impact from each of the variables can also be provided. In the illustrated example, zoning data had a 30% impact on the property data category value (which is used along with the other category values to determine the septic system score as discussed with reference to FIG. 2), while the type of structure on the property had a 20% impact on the property data category value. A similar breakdown of any number of different variables can be provided for any of the data categories illustrated around the septic system score. According to some embodiments, any of the data variables shown in breakout window 1502 can be further clicked or touched to open further details about that particular data variable, which may include raw values or comparisons to other septic systems in the area.

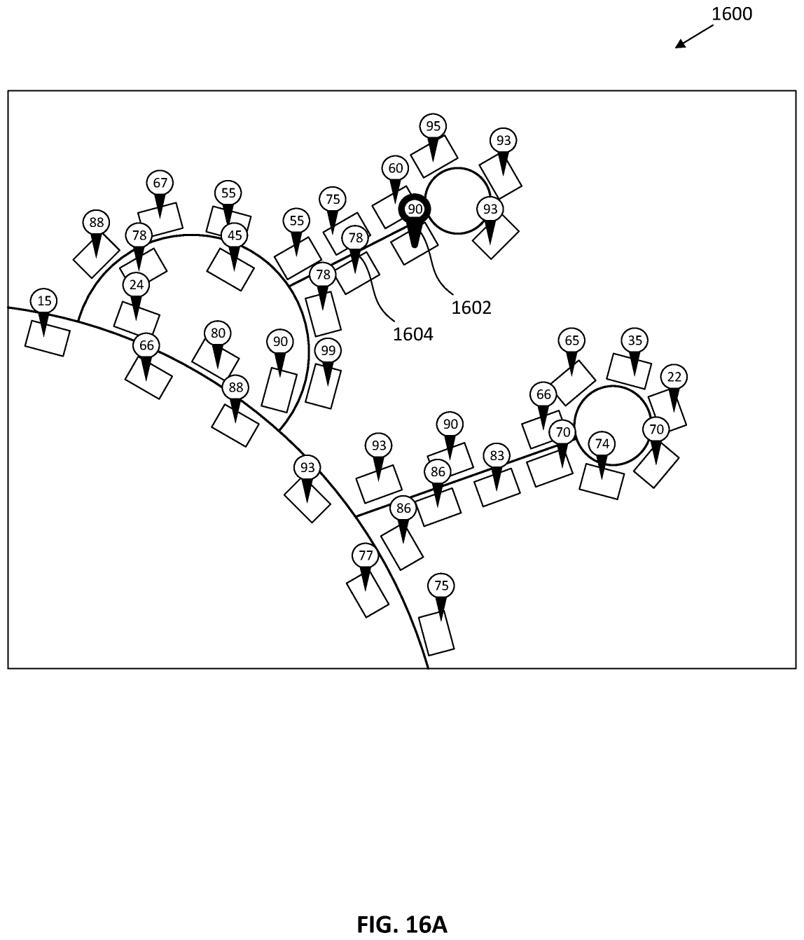

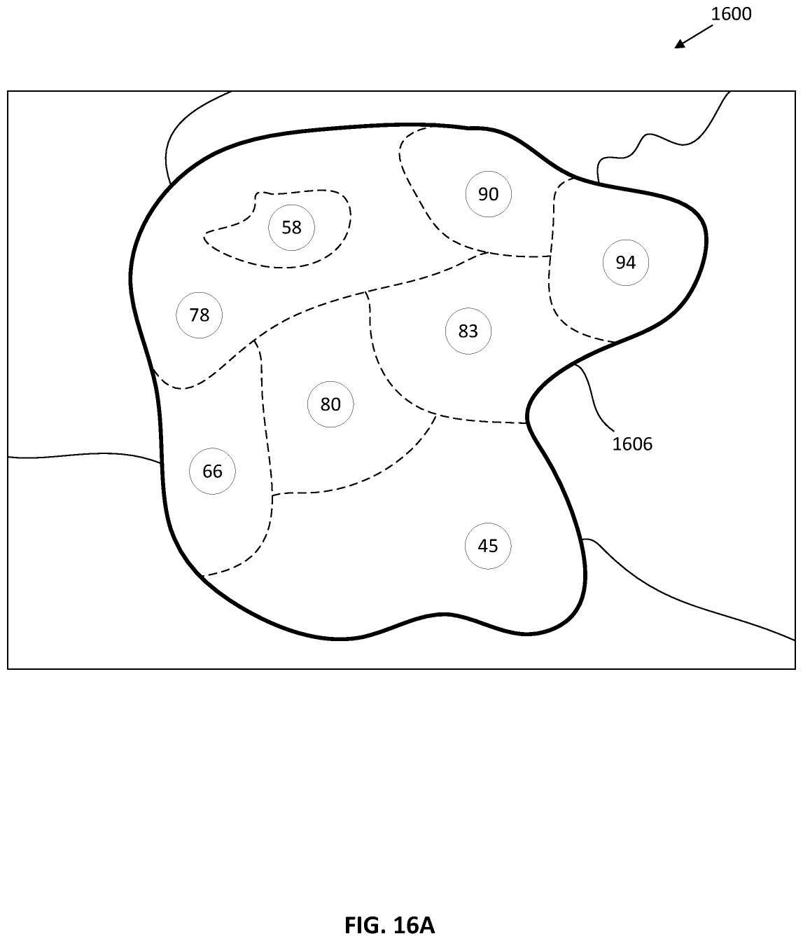

FIG. 16A illustrates another example graphical user interface 1600 that shows a geographic map of a given location showing septic system scores for multiple different systems in the region, according to some embodiments. The various septic system scores can be provided for individual systems at different home or business addresses, or the scores can show average values from multiple septic systems in a given area.

According to some embodiments, a septic system of interest has its septic system score 1602 highlighted to make it stand out on the map. Septic system score 1602 may be associated with the user's own septic system or to another septic system of interest that is indicated by the user. The score may be shown on the map at the general geographic location where the septic system is located. In the illustrated example, a residential neighborhood is shown with multiple residential properties and other septic system scores 1604 shown for the septic systems at each of the residential properties.

According to some embodiments, color may be used like a heat map to generally show the values of the different septic system scores for different regions. For example, regions having average scores above 80 may be shown in green, regions having average scores between 60 and 80 may be shown in yellow, regions having average scores between 50 and 60 may be shown in orange and regions having scores below 50 may be shown in red. The colors may transition seamlessly from one into another across the map.

According to some embodiments, clicking or touching any of the septic system score indicators can bring up any further information about the associated septic system. This further information can include values for any of the various septic system variables or comparison metrics to how different data categories of the septic system compare to the other septic systems within a given geographic area.

According to some embodiments, septic systems can be viewed in a geographic area at different zoom levels. FIG. 16A illustrates an example of looking at septic system scores at generally a micro level (e.g., section of a neighborhood). FIG. 16B illustrates an example of graphical user interface 1600 that has been zoomed out to look at a more macro level (e.g., across a county). For example, a geographic map view of a county 1606 can be provided along with various regions identified by the aggregate scores of the septic systems in each of the regions. The aggregate septic system scores are shown within circles in each of the regions (identified with dashed lines). The more macro-level view allows a user to quickly view what regions generally have better septic system scores compared to others.

According to some embodiments, graphical user interface 1600 allows a user to dynamically change the zoom level, such that zooming in to one of the particular regions would show a collection of septic system scores for smaller regions within the particular region. Further zooming in may show a collection of septic system scores for an even smaller area, such as a particular neighborhood as illustrated in FIG. 16A.

According to some embodiments, graphical user interface 1600 can also display environmental data on the map along with the septic system scores. The environmental data may show soil data, watershed data, lake data, forestation data, or any other type of data associated with the environment. As noted above, such environmental data can be overlaid with the septic system scores to visualize how the local environment may be impacting the septic system in a given area or vice versa.

According to some embodiments, the number of total septic system scores displayed on the map at any zoom level can be increased or decreased depending on filtering criteria set by the user. The septic system scores can be filtered using any number of different thresholds related to any of the septic system variables or the septic system scores themselves. For example, the map can be filtered to only display septic system scores above 75. In some other examples, the map can be filtered to only display septic system scores that represent septic systems having a tank size above a certain threshold or having been built only in the last 10 years. In some other examples, the map can be filtered based on identified risk levels or hotspots for different regions. In some embodiments, other data associated with contracting work can be provided on the map, such as customer density in certain regions, number of septic tank contractors in a given region, or total revenue generated from septic tank maintenance and/or installation in a given region, to name a few examples.

### Example AI Model

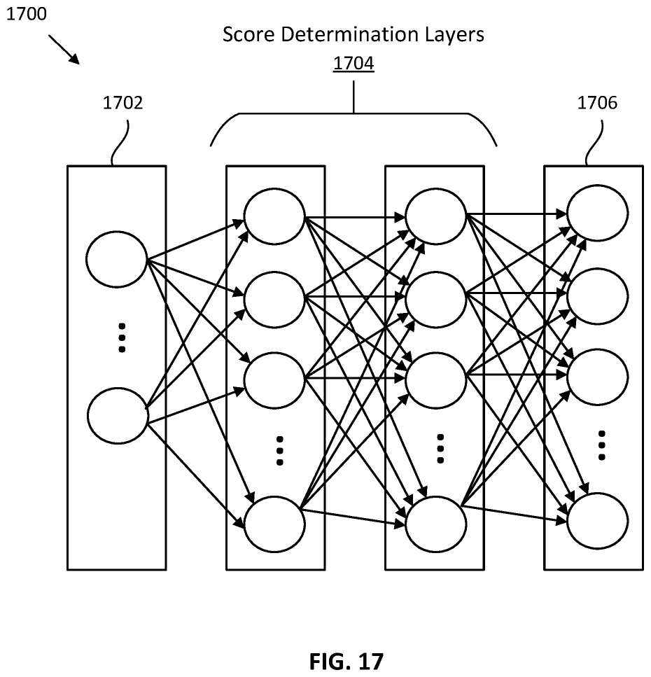

FIG. 17 illustrates an example of a neural network 1700 that can be used to generate a septic system score based on a collection of different septic system variables, such as any of the variables described in FIGS. 3-9. Neural network 1700 includes an input layer 1702, one or more septic variable layers 1704, and an output layer 1706.

According to some embodiments, each of the layers of neural network 1700 include neurons that represent mathematical functions and/or weights applied to data received as input to the neuron. The output of a neuron of one layer is received by each of the neurons in the proceeding layer. Accordingly, input layer 1702 of neural network 1700 can include any number of neurons that receive the collection of different septic system variables, contractor variables, or market variables, according to some embodiments.

According to some embodiments, septic variable layers 1704 are configured during training of neural network 1700 to identify patterns and trends in the received inputs in order to perform various predictions or score generations, such as generating a septic system score based on received septic system variables, predicting septic system risk, or using both septic system variables and contractor variables to match contractors with a given septic system job. The number of septic variable layers 1704, the number of neurons in each of the layers, and the function performed by each neuron may be established during supervised training as neural network 1700 learns how to perform its various predictions or score generations. Accordingly, the characteristics (e.g., number of layers, number of neurons in a given layer, etc.) of septic variable layers 1704 can be different depending on various training factors. According to some embodiments, neural network 1700 is trained using a training set of septic system variables and/or contractor variables of a number of different septic systems and/or contractors along with expected scores for those different septic systems and/or contractors. Accordingly, neural network 1700 learns how to map the input variables to a final output. In some embodiments, unsupervised training of neural network 1700 takes place where various septic system variables and/or contractor variables are fed to neural network 1700 after being collected, thus continually updating the AI with the new data.

Similar to a neural network, other machine learning models such as a Random Forest Regressor model can be used to determine a septic system score based on a collection of different septic system variables, such as any of the variables described in FIGS. 3-9. Machine learning models, especially tree-based models like Random Forest, operate on complex decision trees and ensembles. However, according to some embodiments, the general process can be described as follows:

Step 1: Data Preparation. Transform the numeric features of the various septic system parameters to ensure they're on a similar scale, typically using Min-Max scaling or Z-score normalization. Then, convert the categorical features into numeric values through one-hot encoding or label encoding, according to some examples.

Step 2: Model Training. Divide the data into training and testing sets, e.g., 80% for training and 20% for testing. Once the data has been split, the regressor is initialized with parameters like the number of trees (estimators), max depth for trees, and others based on the complexity of the data. The model is then trained using the features (X_train) and target variable (y_train) from the training set.

Step 3: Prediction. For a new septic system that the model is attempting to determine a septic score for, prepare the data associated with that new system in the same format as the training data, including normalization and encoding. Then, use the trained model to predict performance scores based on the new system's features.

Step 4: Output Interpretation. The model outputs a performance score for the septic system, reflecting its predicted effectiveness and sustainability based on the input parameters.

Another machine learning model is a dynamic simulation model. Dynamic simulation models offer a powerful means to understand and predict the behavior of complex systems like septic systems over time. By incorporating interactions between various factors and simulating these under different conditions, these models can provide valuable insights into system performance, sustainability, and potential points of failure. According to some embodiments, the general process for using a dynamic simulation model to determine the septic system score for a given system can be described as follows:

Step 1: Model Construction. The main components of the septic system are identified, including the tank, drain field, soil layers, and any treatment technologies used, to name a few examples. Environmental factors may also be considered such as weather data or soil type. According to some embodiments, a framework is established to identify how these components interact with one another. Examples may include how effluent flows from the tank to the drain field, how soil conditions affect filtration, or how heavy rain affects soil saturation and, consequently, effluent filtration efficiency. Feedback mechanisms and/or model interactions may also be incorporated in the model, such as the impact of system overload on effluent treatment quality or the effect of maintenance practices on system longevity.

Step 2: Simulation. Various operational and environmental conditions under which the system might operate can be defined, such as daily load variations, rainfall patterns, and maintenance frequencies. The model may then be executed over a simulated time frame while tracking how the system responds to the input scenarios. This could include changes in effluent quality, system capacity, or failure rates.

Step 3: Analysis and Scoring. The outcomes of the simulation may be analyzed to assess key performance indicators, such as system efficiency, failure rates, or environmental impact. Based on the performance under various scenarios, a septic system score (or any number of category scores or values) may be generated to reflect the system's resilience, sustainability, and effectiveness. This could involve setting thresholds for performance indicators that correspond to different score levels.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

Numerous specific details have been set forth herein to provide a thorough understanding of the embodiments. It will be appreciated, however, that the embodiments may be practiced without these specific details. In other instances, well known operations, components and circuits have not been described in detail so as not to obscure the embodiments. It can be further appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

What is claimed is:

1. A computer-implemented method for generating a septic system score for a septic system, the method comprising:
identifying, using a processing device, a plurality of septic system categories, wherein each of the septic system categories comprises a plurality of septic system variables associated with the septic system;
for each of the septic system categories, generating, using the processing device, a category value based on the plurality of septic system variables corresponding to the category, wherein the generating comprises
weighting one or more of the plurality of septic system variables to create weighted variables, and
combining the weighted variables to generate the category value;
combining, using a processing device, the category values to generate the septic system score; and
displaying, using a processing device, the septic system score.

2. The method of claim 1, wherein identifying the plurality of septic system categories comprises retrieving one or more of the plurality of septic system variables of a given septic system category from a networked database.

3. The method of claim 1, wherein the plurality of septic system categories comprises at least one of a sample data category, a historical data category, an inspection data category, a geographic/environmental data category, a system features category, a property data category, or a socio-demographic data category.

4. The method of claim 1, wherein at least one of the plurality of septic system variables of any of the plurality of septic system categories includes a time-dependent variable.

5. The method of claim 1, wherein the weighting comprises applying a weight to a given variable of the plurality of septic system variables based on how a value of the given variable compares to the same variable from other septic systems in geographic proximity to the septic system.

6. The method of claim 1, wherein the weighting comprises applying a weight to a given variable of the plurality of septic system variables based on a relationship between the given variable and one or more other variables of the plurality of septic system variables.

7. The method of claim 6, wherein the relationship is determined by a trained model.

8. The method of claim 1, wherein the septic system score is expressed as a number between 0 and 100.

9. The method of claim 1, wherein identifying the plurality of septic system categories comprises retrieving one or more of the plurality of septic system variables via manual input from a user.

10. The method of claim 1, further comprising:
receiving an altering input from a user, the altering input providing a change to one or more of the plurality of septic system variables from any of the plurality of septic system categories;
generating an updated septic system score based on the changed one or more septic system variables; and
displaying the updated septic system score.

11. The method of claim 1, further comprising displaying a notice of a service provided by a provider in geographic proximity to a geographic location of the septic system, wherein the service and/or the provider is selected based on the septic system score.

12. The method of claim 11, further comprising displaying an estimated change to the septic system score that would occur if the service was performed on the septic system.

13. The method of claim 1, wherein displaying the septic system score comprises displaying an annular graph having a plurality of sections, wherein each section of the plurality of sections is associated with a different septic system category of the plurality of septic system categories.

14. The method of claim 13, wherein a size of each section is proportional to an impact the associated septic system category has on the septic system score.

15. The method of claim 13, further comprising:
receiving a user input to select one of the sections of the plurality of sections;
displaying any of the plurality of septic system variables associated with the septic system category corresponding to the selected section; and
displaying values of any of the displayed plurality of septic system variables.

16. The method of claim 1, wherein displaying the septic system score comprises displaying a geographical map that includes a location of the septic system and displaying a graphical indicator at the location that includes the septic system score of the septic system.

17. The method of claim 16, further comprising displaying a plurality of septic system scores from a plurality of other septic systems from other locations on the geographical map and displaying a graphical indicator at each of the other locations that includes a corresponding septic system score of the other septic system at that location.

18. The method of claim 17, wherein the geographical map includes regions having different coloration based on the average values of the septic system scores within each of the regions.

19. A computer program product including one or more non-transitory machine-readable media having instructions encoded thereon that when executed by at least one processor causes a process for generating a septic system score for a septic system, the process comprising:
identifying a plurality of septic system categories, wherein each of the septic system categories comprises a plurality of septic system variables associated with the septic system;
for each of the septic system categories, generating a category value based on the plurality of septic system variables corresponding to the category, wherein the generating comprises
weighting one or more of the plurality of septic system variables to create weighted variables, and
combining the weighted variables to generate the category value;
combining the category values to generate the septic system score; and displaying the septic system score.

20. A system configured to generate a septic system score for a septic system, the system comprising:
at least one processor;
a data accumulator, executable by the at least one processor, and configured to collect a plurality of septic system variables associated with the septic system from across a plurality of different septic system categories;
a septic score generator, executable by the at least one processor, and configured to
for each of the septic system categories, generate a category value based on the plurality of septic system variables corresponding to the category by weighting one or more of the plurality of septic system variables to create weighted variables and combining the weighted variables to generate the category value, and
combine the category values to generate the septic system score; and
a display module, executable by the at least one processor, and configured to display the septic system score.
